(19) United States
(12) Patent Application Publication
(10) Pub. No.: US 2021/0065416 A1
(43) Pub. Date: Mar. 4, 2021

(54) Interactive Data Visualization User Interface Generator for Iterative Data Set Exploration

(71) Applicant: AnnielyticX, Inc., Natick, MA (US)

(72) Inventor: Annie W. Shum, Hopkinton, MA (US)

(73) Assignee: AnnielyticX, Inc., Natick, MA (US)

(21) Appl. No.: 17/061,294

(22) Filed: Oct. 1, 2020

Related U.S. Application Data
(63) Continuation-in-part of application No. 17/010,616, filed on Sep. 2, 2020.
Application No. 17/010,616 is a continuation-in-part of application No. 16/501,133, filed on Sep. 3, 2019.

(51) Int. Cl. G06T 11/20; G06F 3/0482; G06F 16/26

(52) U.S. Cl. CPC G06T 11/206; G06F 3/0482; G06T 2200/24; G06F 16/26; G06T 11/203

(57) ABSTRACT

Methods and systems related to the fields of data science and graphical user interfaces are disclosed. One method for providing an interactive data visualization user interface includes generating a visual map using the data set. The visual map can include a physical coordinate system formed using physical vectors representing values of vector attributes. The vector attributes can be selected from attributes of the data set and are referred to as vector attributes because they have been selected for representation via the physical vectors. The method can include receiving a selection of a vector overlay display option and generating an overlay for the physical vectors. The overlay can relate to the attribute values associated with the physical vectors and does not necessarily relate to the physical coordinate system.

### CROSS REFERENCE TO RELATED APPLICATIONS

This application is a continuation in part of U.S. patent application Ser. No. 17/010,616, filed Sep. 2, 2020, which is a continuation in part of U.S. Provisional Patent Application No. 62/895,351, filed Sep. 3, 2019 and converted to nonprovisional form on Sep. 2, 2020, all of which are incorporated by reference herein in their entirety for all purposes.

### BACKGROUND

There are 2.5 quintillion bytes of data created every day. Many technical fields and engineered systems that were once data starved are now so overwhelmed with data that they are currently limited not by the amount of data that can be collected and stored, but by how much of that data can be processed for and actionably comprehended by a decision maker. The modern field of data science is an interdisciplinary and rapidly developing technical area that has emerged to deal with the need to design, collect, and analyze large sets of data to address this new limitation.

Although the field of data science is interdisciplinary, those of ordinary skill in the art of data science generally have technical skills in at least one of the fields of data manipulation, data collection, statistical analysis, machine learning, and data mining. These technical experts are often tasked with providing insights to nontechnical individuals who need to make decisions based on information that can be gleaned from large data sets. The insights are often provided in the form of reports that show relationships within a data set such as pie charts, bar graphs, timelines, maps, line charts, or pivot tables. The term “nontechnical” here refers to users who are not skilled in the field of data science. However, the decisions makers may be highly skilled in separate and distinct technical fields. As expertise is not free, and as more and more fields become dependent upon larger and larger data sets, it becomes increasingly less likely that you will find someone who is both an expert in the field in which the data is required to be understood and applied and someone who is an expert in data science generally.

The present trends outlined above lead to a situation in which at least two parties are needed to glean actionable insights from data. Currently, most decision space oriented data science projects require a data scientist and decision maker to collaborate through a process involving an analyst generating a report for a decision maker, the two parties meeting to discuss the report, and the analyst returning to change or edit the report in an iterative process before a final decision can be made or a required level of understanding can be reached.

### SUMMARY

Methods and systems related to the fields of data science and graphical user interfaces are disclosed herein. Specific embodiments of the invention disclosed herein provide systems and methods for generating an interactive data visualization user interface (VUI) for a given data set. A data set including any number of entries and attributes can be explored in an intuitive and appealable manner through the interactive VUI. The VUI can include visual maps for displaying information. The visual maps can include physical vectors that represent values of the different attributes of the data set. The visual maps can also include graphical value representations of point values derived from the data set. The physical vectors of the visual maps can be vector curves, such as rings, or line vectors, such as spokes. The graphical value representations can be distributed along the physical vectors representing a point value in association with the attribute value that the physical vectors represent.

In specific embodiments of the invention, an overlay for the physical vectors can be generated. The overlay can relate to the attribute values that the physical vectors represent. The physical vectors can form a physical coordinate system on which graphical value representations can be distributed and the overlay does not necessarily relate to the physical coordinate system. The overlay can include fill patterns for the physical vectors on the visual map. An interface can be provided so that a selection of a vector overlay display can be received.

Different layers of the data set can be explored through the generation of different visual maps for the interactive VUI. The interactive VUI can be generated by using a VUI generator. The VUI generator can allow for iterative visual exploration of the data set via multilayered slicing and reorganizing of the data. Furthermore, in specific implementations, the VUI generator can afford these capabilities to nontechnical users in an intuitive manner to allow them the opportunity to identify trends, outliers, correlations, and patterns in the data set.

Different users of the interactive VUI can be able to explore the same data set in different ways in accordance to their specific needs. An interactive VUI generated in accordance with specific embodiments of the invention can allow users to dig as deep into the data set as the data set allows, while keeping the layout simple and intuitive and providing the information in layers, so that there is no overcrowding of information in the interactive VUI. Users can interact with the interactive VUI in multiple ways to generate new visual maps and explore subsequent layers of the data set. In specific embodiments of the invention, users is also able to navigate back through the previous layers of the data set via a navigation interface in the interactive VUI.

In specific embodiments of the invention, a computer-implemented method for providing an interactive data visualization user interface for a data set is provided. The method comprises generating a first visual map using the data set. The map can be generated by selecting, from a set of attributes of the data set, a set of vector attributes and by forming a physical coordinate system using a set of physical vectors. The set of physical vectors represent values of the set of vector attributes. The method additionally comprises receiving a selection of a vector overlay display option and generating, in response to receiving the selection of the vector overlay display option, an overlay for at least one vector in the set of physical vectors. The overlay relates to an attribute value, for an attribute from the set of attributes, associated with the at least one vector, and does not relate to the physical coordinate system.

In specific embodiments of the invention, a non-transitory computer-readable media accessible to one or more processors is provided. The non-transitory computer-readable media stores instructions which, when executed by the one or more processors, implement a method for providing an interactive data visualization user interface for a data set. The method comprises generating a first visual map using the data set. The map can be generated by selecting, from a set of attributes of the data set, a set of vector attributes and by forming a physical coordinate system using a set of physical vectors. The set of physical vectors represent values of the set of vector attributes. The method additionally comprises receiving a selection of a vector overlay display option and generating, in response to receiving the selection of the vector overlay display option, an overlay for at least one vector in the set of physical vectors. The overlay relates to an attribute value, for an attribute from the set of attributes, associated with the at least one vector, and does not relate to the physical coordinate system.

In specific embodiments of the invention, a computer-implemented method is provided. The method comprises selecting, from a set of attributes of a data set, a set of vector attributes, and forming a physical coordinate system using a set of physical vectors. The set of physical vectors represent values of the set of vector attributes. The method additionally comprises generating an overlay for at least one vector in the set of physical vectors, wherein the overlay relates to an attribute value, for an attribute from the set of attributes, associated with the at least one vector, and does not relate to the physical coordinate system.

### BRIEF DESCRIPTION OF THE DRAWINGS

FIG. 1 illustrates a flow chart for a set of methods for providing an interactive VUI for a data set, in accordance with specific embodiments of the invention disclosed herein.

FIG. 2 illustrates an example of the characteristics of a visual map of a layer of a data set, in accordance with specific embodiments of the invention disclosed herein.

FIG. 3 illustrates a visual map generated upon the selection of an attribute value in the visual map of FIG. 2, in accordance with specific embodiments of the invention disclosed herein.

FIG. 4A illustrates a visual map generated upon the selection of an attribute value in the visual map of FIG. 3, in accordance with specific embodiments of the invention disclosed herein.

FIG. 4B illustrates an example of the aspect of the visual map from FIG. 3 when accessed from a subsequent layer, in accordance with specific embodiments of the invention disclosed herein.

FIG. 5 illustrates an example of a visual map including a large number of attribute values, in accordance with specific embodiments of the invention disclosed herein.

FIG. 6A illustrates an example of a visual map including a first subset of the attribute values from FIG. 5, in accordance with specific embodiments of the invention disclosed herein.

FIG. 6B illustrates an example of a visual map including a second subset of the attribute values from FIG. 5, in accordance with specific embodiments of the invention disclosed herein.

FIG. 7 illustrates a visual map including an outer gauge data summary element, in accordance with specific embodiments of the invention disclosed herein.

FIG. 8 illustrates an example of a visual map for a lifestyle tracking application, in accordance with specific embodiments of the invention disclosed herein.

FIG. 9 illustrates an example of a visual map for a skin care plan application, in accordance with specific embodiments of the invention disclosed herein.

FIG. 10 illustrates an example of a visual map for health-related metrics analysis, in accordance with specific embodiments of the invention disclosed herein.

FIG. 11 illustrates an example of a visual map for health-related metrics and risk assessment, in accordance with specific embodiments of the invention disclosed herein.

FIG. 12 illustrates an example of a visual map for the health-related metrics and risk assessment of FIG. 11, but including data from various users at different times, in accordance with specific embodiments of the invention disclosed herein.

FIG. 13 illustrates an example of a visual map for the health-related metrics and risk assessment of FIG. 11, but including data from various users and different metrics, in accordance with specific embodiments of the invention disclosed herein.

FIG. 14A illustrates an example of a visual map for a sales plan including an external summary by product, in accordance with specific embodiments of the invention disclosed herein.

FIG. 14B illustrates an example of a visual map for a sales plan including an external summary by annual sales, in accordance with specific embodiments of the invention disclosed herein.

FIG. 15 illustrates an example of a visual map including an external gauge and indicator, in accordance with specific embodiments of the invention disclosed herein.

FIG. 16 illustrates an example of a visual map for a skin care plan application including different graphical value representation formats, in accordance with specific embodiments of the invention disclosed herein.

FIG. 17 illustrates a second flow chart for a second set of methods for providing an interactive VUI for a data set, in accordance with specific embodiments of the invention disclosed herein.

FIG. 18 illustrates an example of a visual map generated with the method of FIG. 17 and including an overlay on the line vectors, in accordance with specific embodiments of the invention disclosed herein.

FIG. 19 illustrates an example of a visual map generated with the method of FIG. 17 and including an overlay on the vector curves, in accordance with specific embodiments of the invention disclosed herein.

FIG. 20 illustrates an example of a visual map generated with the method of FIG. 17 and including an overlay on the line vectors and the vector curves, in accordance with specific embodiments of the invention disclosed herein.

FIG. 21 illustrates an example of a visual map generated with the method of FIG. 17 and including graphical value representations, in accordance with specific embodiments of the invention disclosed herein.

FIG. 22 illustrates an example of a visual map generated with the method of FIG. 17 and including an overlay on the vector curves where one of the vectors is selected, in accordance with specific embodiments of the invention disclosed herein.

FIG. 23 illustrates an example of a visual map generated with the method of FIG. 17 and including an overlay on the line vectors where one of the vectors is selected, in accordance with specific embodiments of the invention disclosed herein.

### DETAILED DESCRIPTION

Methods and systems related to the fields of data science and graphical user interfaces in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Specific embodiments of the invention disclosed herein provide a generator for an interactive data visualization user interface (VUI) for a given data set. The VUI generator can allow for iterative visual exploration of the data set via multilayered slicing and reorganizing of the data. Furthermore, in specific implementations, the VUI generator can afford these capabilities to nontechnical users in an intuitive manner to allow them the opportunity to identify trends, outliers, correlations, and patterns in the data set. Furthermore, in specific implementations, the VUI generator can allow multiple parties to collaboratively explore and discuss the data either in an in-person meeting, such as by displaying the VUI on a large screen in a meeting room, or remotely, such as by displaying the VUI on a shared screen. These affordances can transform the traditional siloed roles of data report generation and analysis into a collaborative partnership to increase productivity and growth, and furthermore generally allow VUI users to glean insights from data, reveal data stories, architect attention, and engender the exchange of ideas.

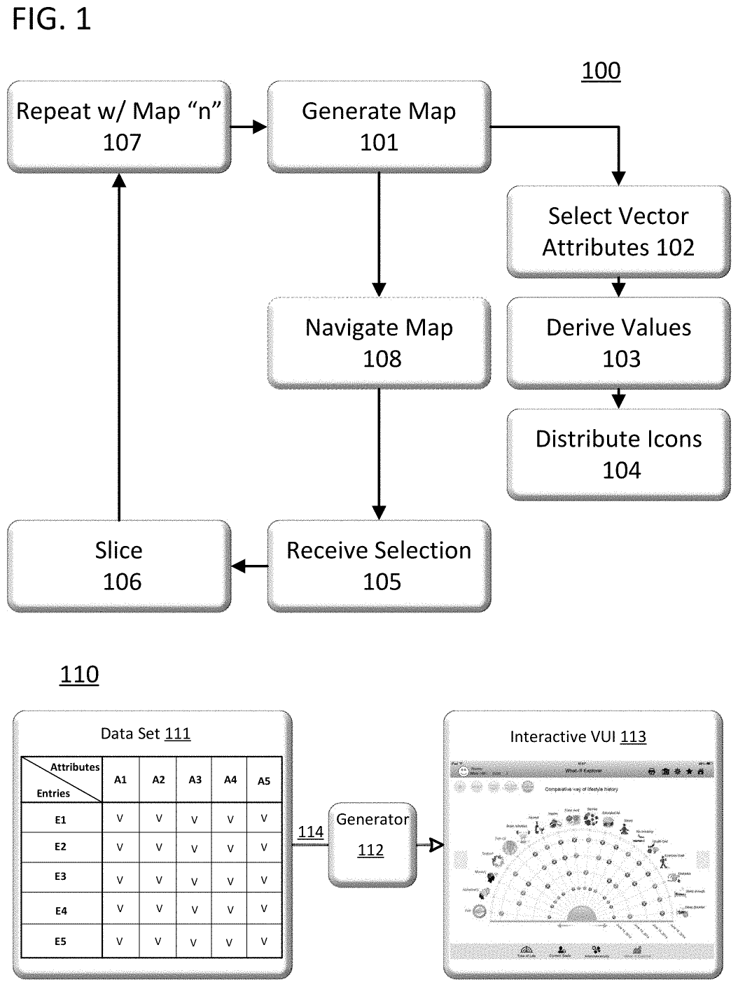

FIG. 1 illustrates a flow chart 100 for a set of computer-implemented methods for providing an interactive VUI for a data set. The steps of the method can be executed by a VUI generator. FIG. 1 also includes a basic block diagram 110 of the relationship between a data set 111, a VUI generator 112, and an interactive VUI 113. The data set 111 and VUI generator 112 can be connected by an interface 114 such as an application programming interface (API). Alternatively, the generator can be configured to directly access the data set. For example, the generator can be implemented in a server sending queries to a data base and processing the responses. The server could include a Database Management System (DBMS) or any software for managing databases. A query language, such as Structured Query Language (SQL), can be used to query the database. The steps of flow chart 100 can all be executed by VUI generator 112 operating on data set 111 to generate interactive VUI 113.

The data set 111 can be any set of structured or unstructured data stored using any form of data store technology including relational databases, individual computer files, smart servers, cloud storage, intelligent storage, dedicated storage systems or formats, integrated storage, Logical Volume Management (LVM) tools, integrated or remote data storage, Cloud Integrated Storage (CIS), dedicated storage area networks (SAN), Network-attached storage (NAS), unified or multiprotocol storage, etc. In specific embodiments of the invention, the data set 111 can be a single computer file or set of files including a spreadsheet file, diverse forms of look-up tables, pivotable tables or raw data tables, character separated format files, such as CSV or similar files where tabular data is stored as plain text, CMS generated files, etc. As illustrated, the data set can include a set of entries E1-E5 where the set of entries are defined by an associated set of values V for a set of attributes A1-A5. For example, if the data set were a database of users for a website, an entry could be “user 1” and an attribute could be “user-name” with a value “John Smith.” The data set 111 can include any number of entries. The entries can include any number of attributes. The values V can be different values for each entry or attribute, or the same value for some or all the entries or attributes. For example, there can be users with the same name, same age, etc. The data set 111 can take various forms and the illustrated example is not a limitation of the present invention. For example, entries and attributes are not necessarily organized by rows and columns of a unique table as illustrated. Different entries can be associated to attributes in different data structures and even different physical locations.

The VUI generator 112 can be instantiated using computer-readable media and one or more processors. The computer-readable media can be non-transitory. The computer-readable media can be accessible to one or more processors and store instructions which, when executed by the one or more processors, implement a method for providing an interactive data visualization user interface for a data set such as in a method represented by flow chart 100. The generator 112 can store rules regarding how data from the data set 111 should be accessed, processed, and ultimately presented in interactive VUI 113. The generator 112 can also include rules for how the data is processed and presented in response to additional user inputs received via the interactive VUI 113. The generator can be a smart generator or machine learning generator that dynamically harvests the data set 111 to generate dynamic content for the interactive VIU 113 in response to a particular input or pattern of interaction. In this way, the same data set can be used to generate a variety of content for VUI 113 responsive to different factors. The generator can also include rules to produce a new set of data from one or more of the original sets of data and/or inputs form the interactive VIU 113 to generate content for the interactive VIU 113.

The interactive VUI 113 can be instantiated using any form of interactive user interface technology. The output of the interactive VUI 113 could be any visual display medium such as a standard computer display, a projector screen, touch screen, hologram, AR or VR display, or any other visual display medium. The input of the interactive VUI 113 could be provided by any user input technology such as a mouse, touch screen, voice controller, gesture recognition device, or any other user input technology.

The elements of block diagram 110 can be implemented using various computing and/or networking architectures. For example, the connection 114 between the data set 111 and the VUI generator 112 can be an API. In a specific embodiment of the invention, the data set 111 can be an excel file which the VUI generator 112 is given access to via the API. As such, VUI generator 112 can pull data from data set 111 for analysis and processing through API calls to a system tasked with administrating data set 111. In a specific embodiment of the invention, all the elements of block diagram 110 will be part of or powered by a software-as-service SAS platform or cloud architecture. For example, the data set 111 could be an excel file uploaded to a web server via a web portal or an internet accessible database to which a SAS platform is provided access. The SAS platform could then both display the VUI and accept inputs from the user through a cloud native application or internet browser application. The generator 112 can also include a separate API or other interface (not shown) to allow for the generator 112 to be updated or to modify the rules used to generate an interactive VUI 113.

The VUI generator 112 can dynamically generate various visual maps of the data set using raw data from data set 111. The visual maps can be generated for various layers of the data set in which values for different attributes of the entries in data set 111 are presented. The layers can be defined by the user through interactions with the interactive VUI 113. Throughout this disclosure, the term “layer of the data set” will be used to refer to a perspective of the data set, where subsequent layers of the data set can provide different and/or more specific data related to an aspect of the previous layer so that the data set can be analyzed from a different, but related perspective. For example, while a first layer of the data set could include overall information about the number of entries, its attributes and corresponding values, a second layer of the data set could include a filtered data set, where only certain attributes, entries or values are considered. As another example, subsequent layers of the data set could include new data obtained by further processing raw data from a previous layer. For example, a subsequent layer of the data set could include data about the number of entries sharing a same value, or about what that value represents. A subsequent layer of the data set could link one or more entries, attributes and/or values to a different data set to provide further information on that entry, attribute and/or value, etc.

The visual maps generated for each layer can be navigated by the user through interactions with the interactive VUI 113. As will be describe below, specific embodiments of the invention vary in terms of the manner in which each visual map is dynamically generated, the manner in which users are able to define additional layers (i.e., to navigate the data set), and the manner in which users are able to modify the visual map for a given layer (i.e., navigate a layer of the data set).

In specific embodiments, the layers can be iteratively defined by a user of the interactive VUI 113 by selecting attributes presented on the interactive VUI 113 to slice them from a layer of the data set to present a new layer of the data set. The first layer of the data set can include all the attributes of the data set and each subsequent layer can include fewer attributes as they are sliced away. The process of iteratively creating new layers of the data set by slicing attributes can be referred to as navigating “down” into the data set through various layers. In specific embodiments, the iteratively defined layers of the data set can be saved to allow the user to navigate back “up” through the layers they have defined using interactive VUI 113. In specific embodiments of the invention, the user can then subsequently use the interactive VUI 113 to move back down into the data set through a different set of layers.

In specific embodiments of the invention, visual maps of a layer of a data set can have various visual characteristics and display various types of information regarding the data set. The visual characteristics can be defined by at least two sets of physical vectors that represent a set of vector attributes and a set of graphical value representations distributed along the physical vectors. The sets of physical vectors can be associated with vector attributes in the set of vector attributes in a one-to-one correspondence. The sets of physical vectors can be distinguished by a shared visual characteristic associated with each set. For example, one set of physical vectors can have a ring shape and be associated with a “country” value for an entry in the data set while a second set of physical vectors can have a spoke shape overlain on the rings and be associated with a “year” value for an entry in the data set. The individual physical vectors in each set of physical vectors can be associated with a vector attribute value from a set of vector attribute values. For example, one ring in the prior example could be associated with the “Brazil” value for the country attribute while a second ring was associated with the “China” value for the country attribute. The set of graphical value representations can be point values for the attributes. For example, the point values can be the number of entries in the data set that have a given attribute or set of attributes, a value of any attributes for one or more entries, or any information derived from the aforesaid values. The point values can be distributed along the set of physical vectors according to the association of those values with the attributes represented by the physical vectors. For example, if a physical vector represented the attribute value “height 5-6 meters” and a second physical vector represented the attribute value “length 1-2 meters,” graphical representations regarding entries in a data set which shared those values for those attributes could be placed at the intersection of those two vectors. The graphical representation could show the number of entries in the data set with those values, information regarding a “width” attribute for those same entries, or any information derived therefrom for those same entries, at the intersection of those two vectors.

In specific embodiments of the invention, the physical vectors of the map can take on various forms and be placed in various arrangements. The visual characteristic of the map will depend on the display technology used for the interactive VUI in which the map is displayed. For example, the map could be two dimensional if displayed on a standard computer display or three dimensional if presented using an AR or holographic display technology. The map could also be a two-dimensional representation of a three-dimensional structure and be presented on a two-dimensional display along with tools to navigate the map and view different portions of the three-dimensional structure using a two-dimensional viewer. The set of physical vectors could be distributed in various ways. For example, the visual map could be a standard two dimensional grid with two attributes being represented by a set of horizontal physical vectors and a set of overlapping vertical vectors with graphical value representations of the set of point values being distributed within the cells of the grid. As another example, the visual map could be a three-dimensional grid with a third attribute being represented by an overlapping set of width wise vectors with graphical value representations of the set of point values being distributed within voxels in the grid. As another example, the physical vectors can include a set of vector curves having a common focus and a set of overlapping line vectors having a common origin with the set of graphical value representations distributed on the set of intersections of the set of vector curves and the set of line vectors. Although in specific embodiments of the invention, the physical vectors associated with particular attributes can all be orthogonal, overlapping vectors provide the ability to represent two attributes for a given point with one physical point in the map.

In specific embodiments of the invention, a visual map of a data set can be generated in various ways. Flow chart 100 includes a step 101 of generating a visual map. The visual map can be generated by VUI generator 112, using the data set 111. For example, the visual map can be dynamically generated while the data set is being accessed through the application programming interface or other interface between VUI generator 112 and data set 111. The generation of the map can include a step 102 of selecting vector attributes. Vector attributes can be selected from the attributes of the data set 111. Vector attributes can be selected in relation to the data set 111 and the content to be displayed in interactive VUI 113. The VUI generator 112 can be configured to select specific vector attributes for a given type of application. The vector attributes can alternatively or in combination be selected in response to a user interaction with interactive VUI 113. For example, a user of interactive VUI 113 may interact with VUI 113 to select the attributes that would fulfill the user needs in a customizable manner. The vector attributes to be selected can be set by a system manager or designer prior to the generation of the map. The VUI generator 112 can have rules to decide which attributes to select considering a user's profile, a location, prior user's interactions, etc. The VUI generator 112 can be configured to select fixed attributes depending on the type of data to be shown in interactive VUI 113 or the structure of data set 111.

The generation of the map can also include a step 103 of deriving one or more point values from the data set 111. VUI generator 112 can access the data set 111 to derive the point values. For example, generator 112 can read through the data set 111 and compile data related to an aspect of interest or common aspect, and then generate a value representative of the compiled data. In the example given above of a database of users for a website, the entry “user 1” could also include the attribute “user-age”. The VUI generator could then derive a data point value that represents the number of users (entries) within a certain age group. In this way, the data point values do not need to, although they could, be obtained directly from, or be a reflection of, the data set 111, and the data set 111 can be used as raw data to derive data point values that can efficiently provide additional information to the user of the interactive VUI 113. The same data set 111 can then be used to derive and create diverse and rich content for interactive VUI 113 in numerous ways.

The generation of the map can also include a step 104 of distributing one or more graphical value representations, such as icons, of the point values derived in step 103. The graphical value representations can be distributed along physical vectors representing the values of the vector attributes selected in step 102. For example, the physical vectors can be graphical representations of the values of the vector attributes where the graphical value representations can be distributed, such as a line vector or a vector curve. The graphical value representation can be any graphical representation used to illustrate the point values derived in step 103, such as icons of diverse forms and colors, images, color-coded points, etc., as will be described below in more detail.

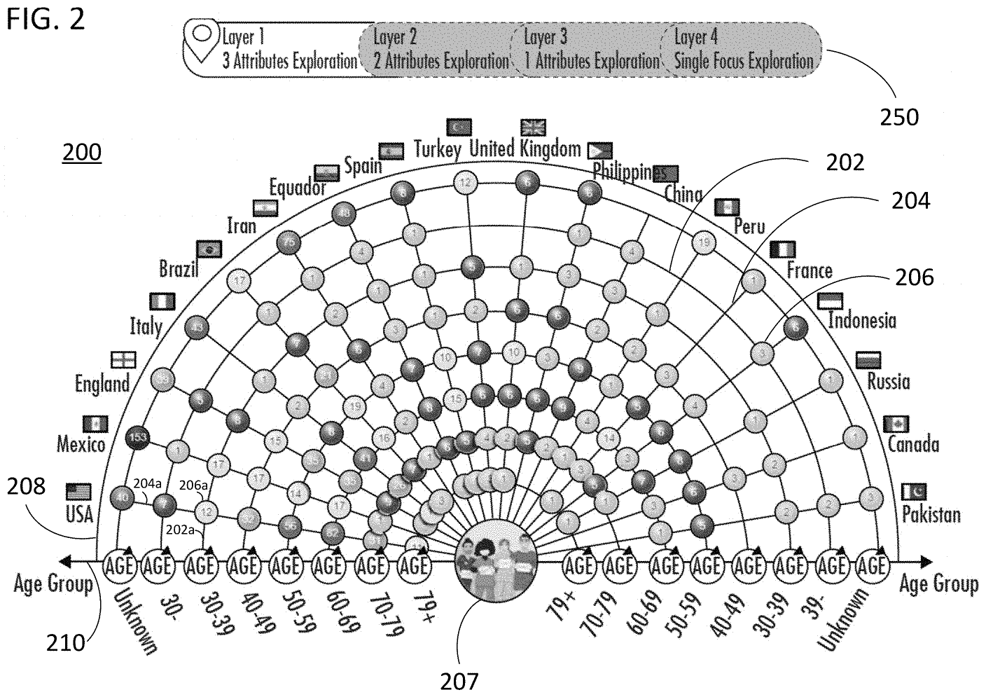

FIG. 2 provides a specific example of the characteristics of a visual map 200 of a layer of a data set in accordance with specific embodiments of the invention disclosed herein. In FIG. 2, the physical vectors include a set of vector curves, such as vector curve 202, having a common focus. In specific embodiments of the invention the set of vector curves can be concentric rings. In specific embodiments of the invention, the set of vector curves can span any number of degrees including 180 degrees (half rings) or 360 degrees (full rings). In FIG. 2, the physical vectors also include a set of overlapping line vectors, such as line vector 204, having a common origin. In this example, the common origin of the line vectors is the center of the rings forming the vector curves. A picture or other icon, such as image 207 in the center of the map, can be added to the map for aesthetica) or informative reasons. FIG. 2 also illustrates graphical value representations (such as 206) of point values, such as the point values derived in step 103 of flow chart 100. The graphical value representations can be distributed, as explained with reference to step 104 of flow chart 100, along the physical vectors. For example, the graphical value representations can be distributed on the intersections of the vector curves and the line vectors, as illustrated in the example of FIG. 2. In this way, the graphical value representations can illustrate the data point derived from the data set 111 in association with the values of the vector attributes represented by the physical vectors.

The map in the example of FIG. 2 represents a data set related to health care personnel that have lost their lives battling the 2019-20 SARS-CoV-2 pandemic. In this example, the vector attributes are “Country”, as represented by the outermost ring 208, and “Age”, as illustrated by line 210. The physical vectors, such as line vector 204 and vector curve 202 represent the values for such vector attributes. The data points in this example represent the number of entries for a given country and age group. For example, graphical value representation 206a (distributed on the intersection of line vector 204a, representing the value USA of the attribute “Country”, and vector curve 202a, representing the value 30-39 of the attribute “Age”), informs that there were, at the time the map was generated, 12 victims in the United States between 30 and 39 years old.

VUI generator 112 can have rules to process the data and present the physical vectors that represent the values of the vector attributes in different ways. For example, the line vectors, such as 204 in the example of FIG. 2, each represent a country from the list of countries associated with vector attribute “Country”, and the vector curves, such as 202, each represent an age group associated with the vector attribute “Age”. Thus, the physical vectors do not necessarily correspond to the value of the vector attribute they represent and can represent such vector attributes in various ways. For example, the physical vectors can directly correspond to the values for the vector attributes (each physical vector represents a country where the vector attribute is “Country”). As another example, the physical vectors can indirectly represent the values for the vector attributes (each physical vector represents an age group where the vector attribute is “Age”).

In specific embodiments of the invention, the graphical representations for point values can take on various forms. In the Example of FIG. 2, the graphical representations, such as 206, for point values are in the form of solid color balls that include numeric information. The graphical representations, such as 206, can be of any shape. For example, they can be in the form of 2D geometric figures such as circles, rectangles, hexagons, etc. or 3D geometric figure such as a cube, cone, etc. The graphical representations can be in the form of irregular figures or specific shapes, such as object shapes or human shapes. The graphical representations can be images, emojis, text, numbers or marked points on the map. The graphical representations can be symbols or signs, such as arrows, hearts, stars, etc. The graphical representations can be of any color. They can be solid shapes or transparent shapes with solid borders. All the graphical representations on a map can be of the same format, such as same color, form, shape, etc. or of multiple formats. The format of the graphical value representations can represent dimensions of the data such as intensity, quantity, type, etc. In the example of FIG. 2, the graphical representations have different colors depending on the range where the numerical value they represent is located. For example, a higher number of victims can be represented in red, while a lower number can be green. Any other color-code can be used. As a different example not illustrated in FIG. 2, graphical value representations in a specific form, such as balls, could represent male victims, and a different shape could represent female victims. This and other combinations of configurations and formats are possible to provide additional information to the users via the format of the graphical value representations. VUI generator 112 can have rules to decide the format of the graphical representations, as will be described below in more detail.

The graphical representations can have information embedded in the form of text, numbers, shapes, figures, etc., such as the number illustrated on each graphical value representation of each data point in FIG. 2. In this way, the graphical representation can represent data points derived from the data set 111 in numerous ways, either by directly projecting information, such as the numeric values in FIG. 2 representing the number of victims in a given country and age group, or by adding context or dimensions to the data by giving it different forms, colors, etc. VUI generator 112 can be configured to format the graphical representations in a specific manner according to certain rules as will be described below in more detail. The graphical representations for point values can then represent the data itself, for example the number 12 in graphical value representation 206a, its association with the values of the vector attributes, by means of its distribution along the physical vectors 204a and 202a, and other dimensions of the point value by means of the color, shape, size, type, etc. of the graphical value representation.

As mentioned previously, in specific embodiments of the invention, the visual map can be used to dive down into a data set. Examples of this process can be described with reference to FIGS. 1 and 2. After the map generation, flow chart 100 includes a step 108 of navigating the map and a step 105 of receiving a selection of at least one attribute value, for example, from the interactive VUI 113. The selection can be given by a user interaction with the interactive VUI. The selection can be via one of the graphical value representations. For example, the user can select a specific graphical value representation by clicking directly on the graphical value representations, such as graphical value representation 206 in FIG. 2, or on a label, button or other interface associated with the graphical value representation. The selection can also be via one of the physical vectors. For example, the user can select a specific physical vector by clicking directly on the physical vector, or on a label, button or other interface associated with the physical vector, such as the name of the countries, flags, or age group labels or icons in FIG. 2. The selection can also be via additional fields, controllers or buttons provided in the interactive VUI. Indications for interaction can be provided by VUI generator 112 so that the user can provide selections intuitively. For example, VUI generator can generate instant messages or prompts indicating “to explore a country, just tap on its flag” or “to explore an age-group, just tap on its age-group icon”.

Flow chart 100 also includes a step 106 of slicing the selected attribute value. By slicing the selected attribute value more information related to that attribute value can be accessed. A new layer of the data set can be harvested and processed by VUI generator 112 to create new content for interactive VUI 113. When one attribute value of the data set is selected, it can be sliced to form a subsequent data set. The slicing can include filtering the entries in data set 111 associated with the selected attribute values to zoom in and obtain more information on that subset of data. The slicing can include, for example, taking all entries from the data set associated with the at least one selected attribute value and discarding all the other entries from the data set. For example, if a user selects the “USA” physical vector, representing the “USA” value for the vector attribute “Country”, the slicing can include a deeper look into the entries that include the “USA” as a value for “Country”, and all other values (countries) can be removed from consideration. As another example, if a user selects a graphical value representation on the intersection of two physical vectors, the slicing can include a deeper look into the entries that include both attribute values (for example “USA” and “50-59”) and discarding all other values (countries and age groups). The slicing can also include discarding the vector attributes in the visual map associated with the selected vector attribute value and replacing them with new vector attributes selected from the attributes of the data set. In the previous example of a selection in the intersection of the values “USA” and “50-59”, the next layer of data can represent entries that include both attribute values, and represents a different set of attributes, other than country and age, because a value for those attributes was already sliced.

Flow chart 100 continues with a step 107 of repeating the generation step. By repeating the generation step it can be possible to generate a visual map using the new layer of the data set in the same way it was generated for the first data set. Those steps can allow for the division of the data into smaller data sets that provide further and more specific information. In this way, data can be analyzed in a “slice and dice” approach, where a user can slice (for example by selecting one specific attribute value) and/or dice (for example by selecting one specific data point) the data currently illustrated through interactive VUI 113 to obtain new information.

The method illustrated in flow chart 100 could include iteratively repeating the receiving, slicing, and generating steps to generate a set of visual maps. In those cases, the selection step in each iteration can be received via the most recently generated visual map in the set of visual maps. In this way, different users can explore the same data set through different paths according to their specific needs, and the information generated by VUI generator 112 and projected by interactive VUI 113 can be responsive to user interactions and be as specific as the user intends it to be, without unnecessarily overcrowding the layout of interactive VUI 113 with information that may be relevant to certain users but not to others. These approaches can allow for an intuitive navigation through the different layers of the data sets and can provide a connection between layers even when it is not efficiently possible to illustrate all layers of the data in a single visual map. In the example of FIG. 2, a user could slice the attribute values, for example by selecting one specific country or age group and understand a second layer of data related to that specific selection. However, it could be complex and even unpracticable to provide all data related to each country or age group in a single iteration for interactive VUI 113.

In specific embodiments of the invention, the visual maps are dynamically generated during each iteration of exploring the data set, including the first. The dynamic generation of the visual maps can be conducted based on rules selected by or algorithms programmed by the designer of the generator. The rules or algorithms can define which vector attributes are selected, which vector attribute values are selected for representation by physical vectors, how the physical vectors are arranged, how the physical vectors appear, what point values are derived for the data set, how the graphical value representations of the set of point values appear, and how the set of graphical value representations are distributed along the physical vectors. The rules or algorithms can be based on the attributes, attribute values, data values, predefined thresholds, and various other factors. The rules or algorithms can utilize predefined thresholds, discovered patterns, correlation, clustering or assessment weights among data set etc. After the first map is presented, the rules can also take into account what attribute values were selected by the user on a previously presented map.

In specific embodiments of the invention, rules or algorithms in the generator can define which vector attributes are selected for a given visual map. The number of vector attributes that can be selected will be a constraint of the characteristics of the visual map. For example, in embodiments in accordance with FIG. 2 the number of vector attributes that can be selected is two because there are two dimensions of physical vectors in the visual map—the curve vectors or “rings” and the line vectors or “spokes.” However, the illustrated ring could also be broken into segments (e.g., from 0 to 45 degrees along the rings and from 45 to 180 degrees along the rings) such that additional vector attributes can be selected for a given map with those segments being reserved for different attributes. Once the number of vector attributes for a given visual map has been selected the generator can select from among the attributes in the data set to determine which should be represented by physical vectors in the set. The order in which new vector attributes are selected can be manually predefined for a specific data set, selected according to a rule which is applied to the attributes for any given data set (e.g., age always before height), or based on the values in the data set (e.g., whichever attribute has the most even distribution of remaining entries across values for that attribute).

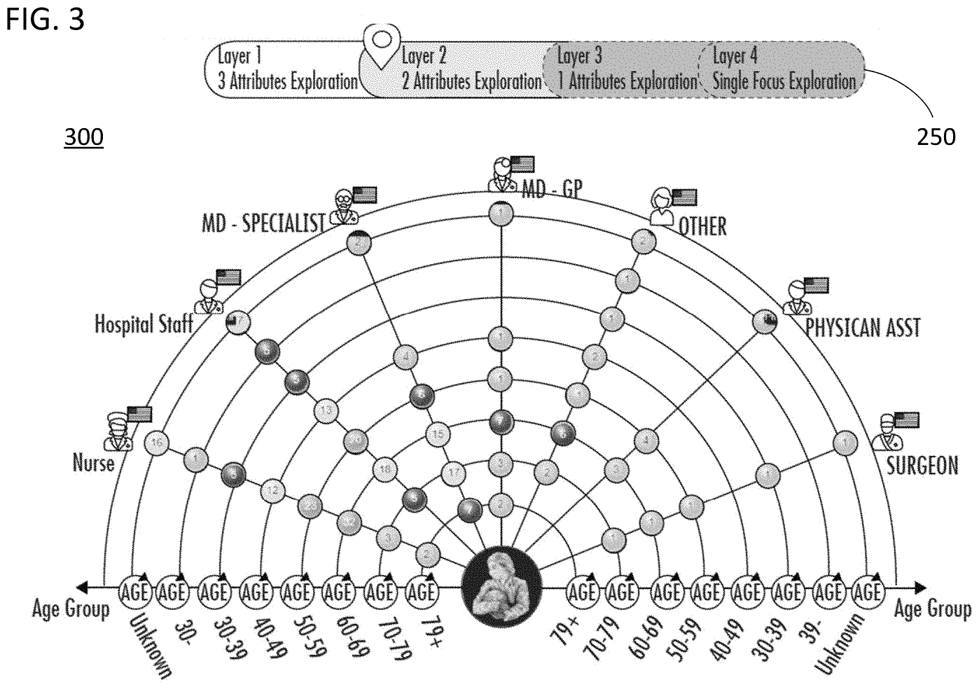

In specific embodiments of the invention, rules or algorithms in the generator can define which vector attributes are selected for a given visual map differently for each subsequent map that is produced based on the prior selections of the user as they moved down into the data set. A specific example of the process of selecting a set of vector attributes for purposes of dynamically generating a virtual map can be described with reference to FIGS. 2, 3 and 4A. FIG. 3 is a second virtual map 300 generated upon the selection of a country attribute in FIG. 2, specifically the “USA” value of the country attribute. As seen in FIG. 3, the country attribute has been sliced from the data set in response to the selection of the specific value “USA”, and the virtual map in FIG. 3 has been generated using a second layer data set in which all the entries are those for which the sliced attribute's value was USA. In specific embodiments of the invention, the set of vector attributes are selected by keeping all the vector attributes from the prior layer and substituting a new vector attribute in place of the selected attribute. In the illustrated case, the vector attribute “age” has been kept and the vector attribute “country” has been replaced by the vector attribute (profession). All the entries now presented on the visual map of FIG. 3 are associated to the “USA” value for the vector attribute “Country”, selected in FIG. 2. In other words, the number of health care professionals represented by profession and age group in FIG. 3 are all from the USA.

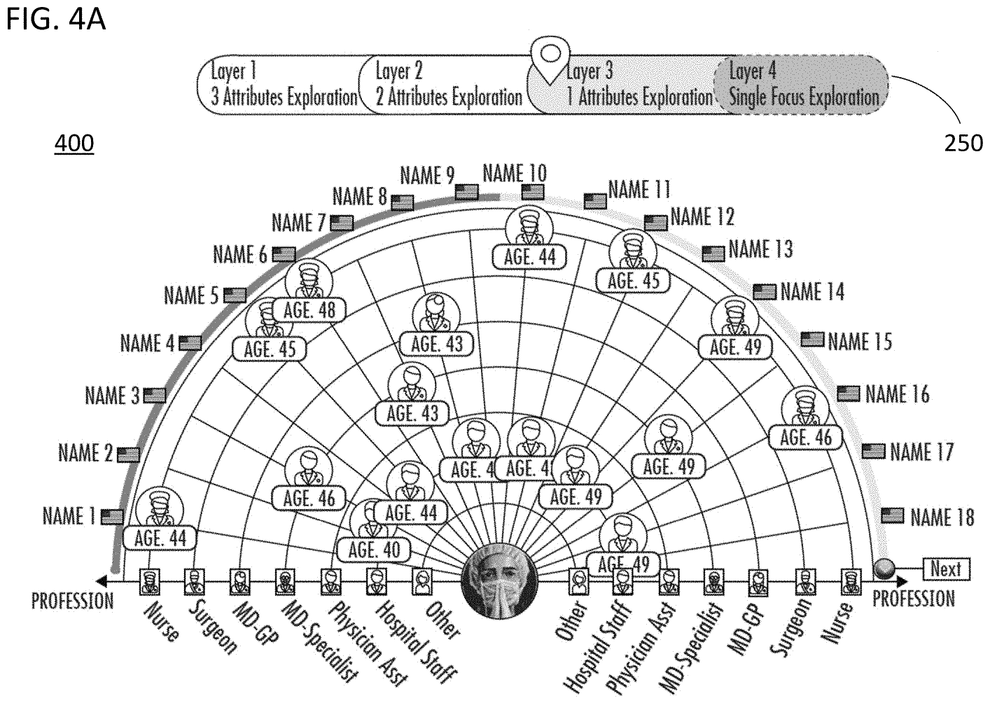

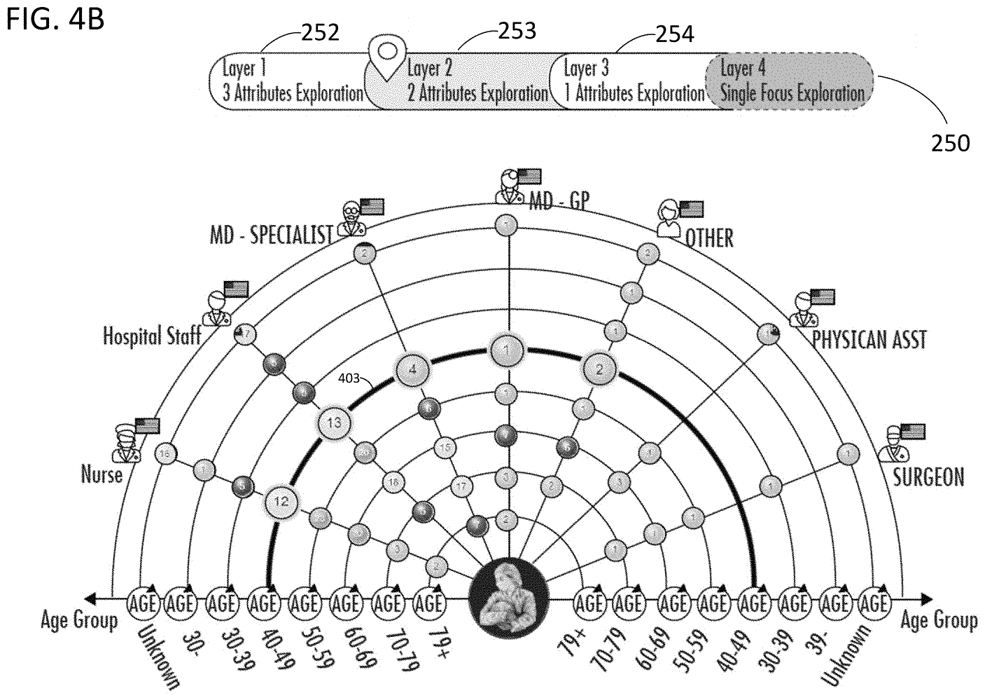

FIG. 4A is a third virtual map 400 generated upon the selection of an age group attribute in FIG. 3, specifically the “40-49” value of the “Age” attribute. As seen in FIG. 4A, the age attribute has been sliced from the data set and the virtual map in FIG. 4A has been generated using a third layer data set in which all the entries are those for which the sliced attribute's value was 40-49. In specific embodiments of the invention, the set of vector attributes are selected by keeping some of the vector attributes from the prior layer and substituting a new vector attributes in place of the vector attribute corresponding to the selected attribute value. In specific embodiments of the invention, a vector attribute that remains on the map can be physically changed and take a different position and/or form in the next iteration of the map. For example, physical vectors representing values of a vector attribute in the form of line vectors can be illustrated as vector curves in a subsequent map while still representing the same vector attribute. In the illustrated transition from FIG. 3 to FIG. 4A, the vector attribute “Profession” has been kept on the map and the vector attribute “Age”, corresponding to the selected attribute value “40-49”, has been replaced by the actual name of the practitioners. The vector attribute “Profession” represented by line vectors in the previous iteration, illustrated in FIG. 3, is now represented by vector curves in the subsequent iteration represented in FIG. 4A.

The examples above represented by FIGS. 2, 3 and 4A illustrate the dynamic generation of visual maps when a selection of one value of a given vector attribute is received. However, as explained before with reference to flow chart 100, it would also be possible to receive a selection via a graphical value representation distributed on the map. As also explained before, the graphical value representations can be distributed along the physical vectors representing values for the vector attributes. If the physical vectors intersect, the graphical value representations can then be distributed on such intersections, as illustrated in the examples above. In those cases, by receiving a selection via the graphical value representation, two or more different physical vectors representing values for two or more different vector attributes can be selected at the same time. A new layer of the data set could be obtained by replacing all the vector attributes currently on the map, or at least the ones associated with the selected graphical value representation, with a new set of vector attributes. A portion (or layer) of the data set for which the values of the previous set of vector attributes were those selected via the graphical value representation can then be explored from a different perspective. In this way, when more than two vector attributes are represented on the map, for example by a 3D map or a map including a different set of physical vectors, such as an additional set of rings with a different common focus, the number of vector attributes with physical vectors intersecting on the map could determine the number of values and associated vector attributes to be sliced in order to form a new layer of data set.

The illustrated cases are non-limiting examples of the multiple possibilities to slice the data and represent the subsequent layers of the data set. Those examples are merely illustrative of the fact that VUI generator 112 can be configured to generate visual maps in numerous ways as appropriated for the type of data being represented.

As mentioned previously, in specific embodiments, the iteratively defined layers of the data set can be saved to allow the user to navigate back up through the layers they have defined when moving down into the data set. Examples of this process can be described with reference to FIGS. 2, 3, 4A and 4B. A navigation interface 250 can be displayed along with the visual maps. In FIG. 2, navigation interface 250 indicates that the “Layer 1” of the data set is being analyzed. Subsequent layers are shown disabled until the user establishes a navigation path through the rest of the data layers. In FIG. 3 navigation interface 250 indicates that the “Layer 2” of the data set is being analyzed, because one of the attribute values was selected in the previous layer, as explained before. Layer 1 is shown enabled because the user already explored that layer of the data. The user can, at any time during further data exploration, go back to that layer and establish a new navigation path. Subsequent layers are shown disabled until the user establishes a navigation path through the rest of the data layers. In FIG. 4A, navigation interface 250 indicates that the “Layer 3” of the data set is being analyzed, because one of the attribute values was selected in the previous layer, as explained before. Layers 1 and 2 are shown enabled because the user already explored those layers of the data. The user can, at any time during further data exploration, go back to those layers and establish a new navigation path. Subsequent layers are shown disabled until the user establishes a navigation path through the rest of the data layers. FIG. 4B illustrates an example of what the previous layer could look like when accessed back through the navigation interface 250. As illustrated, the selected physical vector 403 representing an attribute value sliced in the previous layer, can be highlighted or otherwise surfaced so that the user can keep track of the navigation path through the map and layers of the data.

The user can move through the map via the navigation interface 250 itself once at least part of a navigation path is established. For example, the navigation interface could include elements, such as buttons or links, associated with the visual maps in a one-to-one correspondence. The one-to-one correspondence can be generated dynamically during the iterations of the steps of the method of flow chart 100. The interactive VUI 113 and VUI generator 112 can display the visual maps associated with each element of the navigation interface in response to a selection of one of those elements. For example, the navigation interface 250 can include buttons, such as buttons 252, 253, and 254, illustrated in FIG. 4B. Button 252 can be unambiguously associated with the map 200 illustrated in FIG. 2. Button 253 can be unambiguously associated with the map 300 illustrated in FIG. 3. Button 254 can be unambiguously associated with the map 400 illustrated in FIG. 4A. In this way, a user can select one of the buttons and the corresponding visual map can be displayed. If the user decides to move back through the layers and change the navigation path, for example, by selecting a different age group in FIG. 3, the generation of a new visual map can be triggered, as explained with reference to flow chart 100, and the new visual map can be dynamically associated with the corresponding element of the navigation interface.

In specific embodiments of the invention, rules or algorithms in VUI generator 112 can determine how the physical vectors are distributed and how they appear. VIU generator 112 can have rules to determine the appearance of the physical vectors. The rules can be set by a generator designer, system manager or user of the interactive VUI 113. For example, the position of the physical vectors on the map can be determined based on numerous factors.

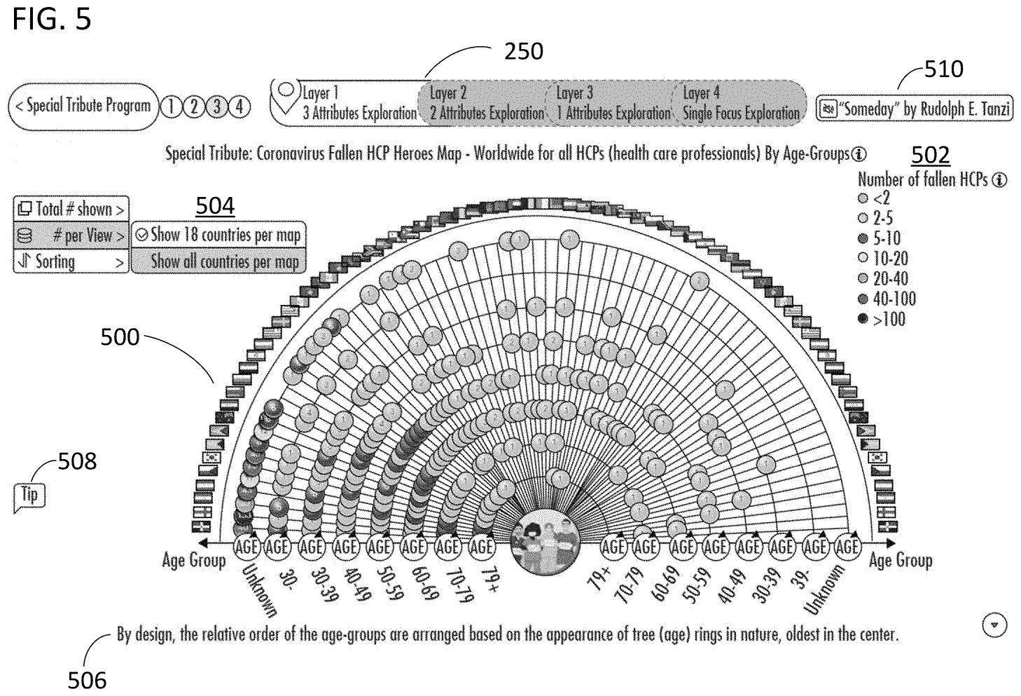

The angle position of for each metric can be determined or calculated by one of the following algorithms: evenly distributed over an allocated angular range, by weighted angular distribution by the measurement values, or predefined weights reflecting priorities, severities, relevance or urgency, etc. The angular distribution of spokes in the examples presented herewith is predominantly even. However, that is not a limitation of the present invention. The physical vectors can be distributed so that the angular space between them varies. For example, line vectors representing less important values can be shown with a smaller angular separation, while line vectors representing more important values can be shown with a larger angular separation, so that the illustrated information is clearer. In specific embodiments of the invention, as will be described below, the amount of values for a given vector attribute will be larger than what the visual map can efficiently display, causing, for example, overlapping between values that can interfere in the visualization. FIG. 5 is an example of this situation. In those cases, the VUI generator can be configured to dynamically increase the angular space between the spokes as the user moves through them, for example when the user moves a cursor over a certain portion of the map. Thus, by controlling the angular space between the physical vectors, interactive VUI 113 can present information in numerous ways. Similar approaches can be considered for the distance between the rings.

The rings or vector curves position can be defined by the radius from a center position and calculated via one of the following algorithms: evenly distributed over a given size of the visual map, weighted distance distribution over an allocated distance range by measurement values, predefined weights reflecting priorities, severities, relevance or urgency, etc. The distribution of the vector curves can be controlled and vary in a similar manner as explained with reference to the angular space above depending on the desired way to illustrate the information in interactive VUI 113.

The line width of each ring or vector curve can be determined or calculated via one of the following algorithms: uniform size, size proportional to the measurement values, predefined weights reflecting priorities, severities, relevance or urgency, etc. In specific embodiments of the invention, as illustrated with reference to FIG. 4B, the width of the vector curves can vary through the navigation path. For example, a vector curve representing a vector attribute value selected by the user can become wider in response to the selection, so that it is evident to the user that the vector curve was selected and/or explored. The width can also vary while the user moves through the map, for example by moving a cursor over the map, to indicate which vector curve is being pointed to.

The color of the rings or vector curves can be decided by one of following algorithms: same color, mapped to the gradient color table by measurement values, predefined weights reflecting priorities, severities, relevance or urgency, etc. In specific embodiments of the invention, as illustrated with reference to FIG. 4B, the color of the vector curves can vary through the navigation path. For example, a vector curve representing a vector attribute value selected by the user can become brighter in response to the selection, so that it is evident to the user that the vector curve was selected and/or explored. The color can also vary while the user moves through the map, for example by moving a cursor over the map, to indicate which vector curve is being pointed to.

The width of each spoke or line vector can be determined or calculated via one of following algorithms: uniform size, size proportional to the measurement values, predefined weights reflecting priorities, severities, relevance or urgency etc. In specific embodiments of the invention, the width of the line vectors can vary through the navigation path. For example, a line vector representing a vector attribute value selected by the user can become wider in response to the selection, so that it is evident to the user that the line vector was selected and/or explored. The width can also vary while the user moves through the map, for example by moving a cursor over the map, to indicate which line vector is being pointed to.

The color of the spokes or line vectors can be decided by one of following algorithms: same color, mapped to gradient color, table by measurement values, predefined weights reflecting priorities, severities, relevance or urgency etc. In specific embodiments of the invention, the color of the line vector can vary through the navigation path. For example, a line vector representing a vector attribute value selected by the user can become brighter in response to the selection, so that it is evident to the user that the line vector was selected and/or explored. The color can also vary while the user moves through the map, for example by moving a cursor over the map, to indicate which line vector is being pointed to.

The total ring or vector curve length (or each space between two adjacent data points on the ring) is larger for rings that have larger radius distance. In this way, more details can be presented for the data points. The selection of the rings for placing the graphical value representations of the point values can be decided by one of the following factors: importance of data points, priority of data points, and order of data points being collected or any data sorting mechanism. In this way, VUI generator 112 can have rules to decide how to distribute the physical vectors considering multiple parameters. These and other algorithms or rules can be implemented so that the physical vectors are highly configurable.

In specific embodiments of the invention, rules or algorithms in the generator can determine what point values are derived for the data set and how the graphical value representations of the set of point values appear, as explained before.

The size of each graphical value representation on the visual map can be decided by one of following algorithms: uniform size, weighted size by measurement values, predefined weights reflecting priorities, severities, relevance or urgency, etc. In specific embodiments of the invention, as illustrated with reference to FIG. 4B, the size of the graphical value representations can vary through the navigation path. For example, the graphical representations on a vector curve representing a vector attribute value selected by the user can become bigger in response to the selection, so that it is evident to the user that the graphical representation or vector curve was selected and/or explored. The size can also vary while the user moves through the map, for example by moving a cursor over the map, to indicate which graphical value representation is being pointed to.

The color of each graphical value representation on the visual map can be decided by one of following algorithms: use the same color, map to a gradient color table by measurement values, predefined weights reflecting priorities, severities, relevance or urgency, etc. The color can be associated to predetermined values. For example, a threshold can be associated to each color so that when a number of entries with a given characteristic represented by the graphical value representation is smaller/larger than the threshold the graphical value representation takes a certain color. In the example illustrated in FIG. 5, the graphical value representations are in the form of colored balls. As can be seen from the information tab 502, the color of the balls represents a range of entries, for example, green if less than two entries, red if more than 40 but less than 100 entries, darker red if more than 100 entries, etc. In this way, it is possible to provide information to the user via the color of the graphical value representations even when the actual value is not illustrated. In the example of FIG. 5 it is not possible to discern the number of entries for each country because some of the values overlap. However, by understanding the color code it is possible to make a preliminary analysis on the data, by determining, for example, the countries with less/more entries. In specific embodiments of the invention, as illustrated with reference to FIG. 4B, the color of the graphical value representations can vary through the navigation path. For example, the graphical representations on a vector curve representing a vector attribute value selected by the user can become brighter in response to the selection, so that it is evident to the user that the graphical representation or vector curve was selected and/or explored. The color can also vary while the user moves through the map, for example by moving a cursor over the map, to indicate which graphical value representation is being pointed to.

In specific embodiments of the invention, rules or algorithms in the generator can determine what sorting order should be applied to assign different attribute values to different physical vectors, and to provide different sorting orders for data point placement relative to the physical vectors.

The sorting order of data point placement positions over the rings or lines can be also calculated by correlation, similarities or clustering discovered among data points. In specific embodiments of the invention, the physical vectors and graphical value representations can be distributed on the map based on the density of the information to be represented. For example, physical vectors that represent values of a vector attribute for which there are numerous entries can be placed as the outermost rings on the map, so that the data points can be distributed along such vector without overlapping. In the same way, physical vectors representing values of a vector attribute for which there are fewer entries can be placed as rings in the center of the map. In this way, VUI generator 112 can have rules to decide how to distribute the physical vectors considering multiple parameters. These and other algorithms or rules can be implemented so that the distribution of the graphical value representations and physical vectors is highly configurable.

In specific embodiments, a visual map will not have enough room to provide a physical vector for all of the vector attribute values in the data set. FIG. 5 illustrates an example of a map 500 including a large number of attribute values (countries). The map 500 in FIG. 5 is illustrated in context with some exemplary interfaces of VUI 113. For example, the interfaces can include informative text, such as text 506, interfaces for playing music, displaying a video, etc., such as interface 510, interfaces for help or tips on navigating the map, such as interface 508, etc. As illustrated, it can be difficult to discern the represented data by analyzing the map. In those cases, VUI generator 112 can determine to represent portions or subsets of the attribute values and give the user the option to move through the not-illustrated attribute values. This determination can be made dynamically such as by making a determination of a level of overlap of the graphical icons or by a simple comparison of a predetermined acceptable number of physical vectors to display for a visual map and the number of vector attribute values in a given data set. The determination can be made by the generator designer or final user of the interface. For example, in the illustrated case of FIG. 5, the interactive VUI can include an interface, such as interface 504, that allows the user to decide how to see the information, for example, how many countries to display at a time. The visual map can in these situations include indicators to this fact and allow a user to cycle through the vector attribute values which are currently displayed as will be described below.

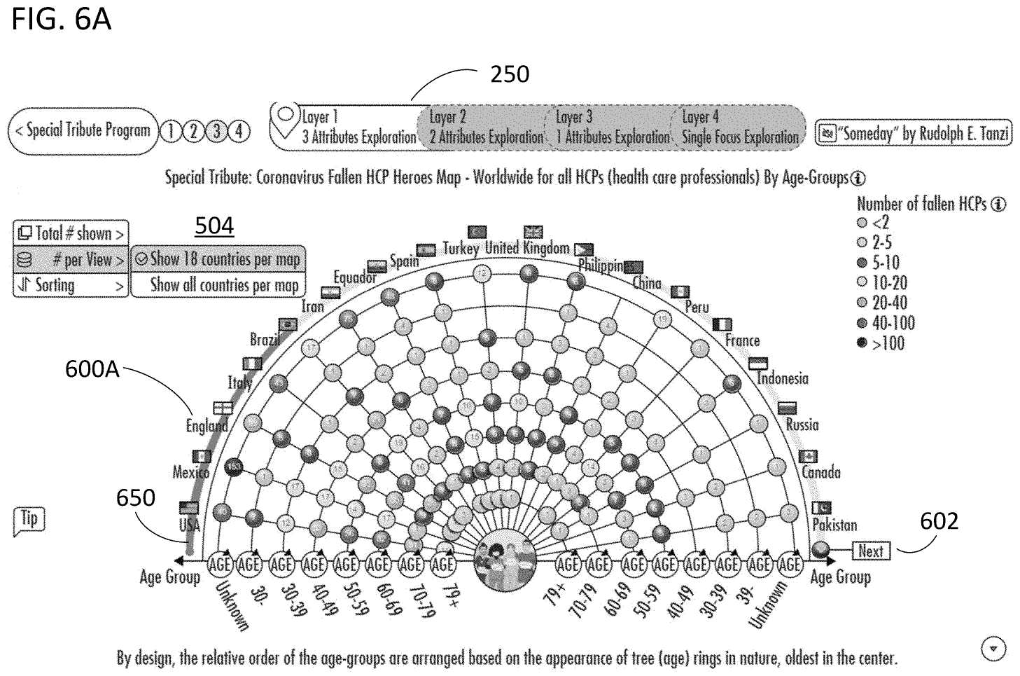

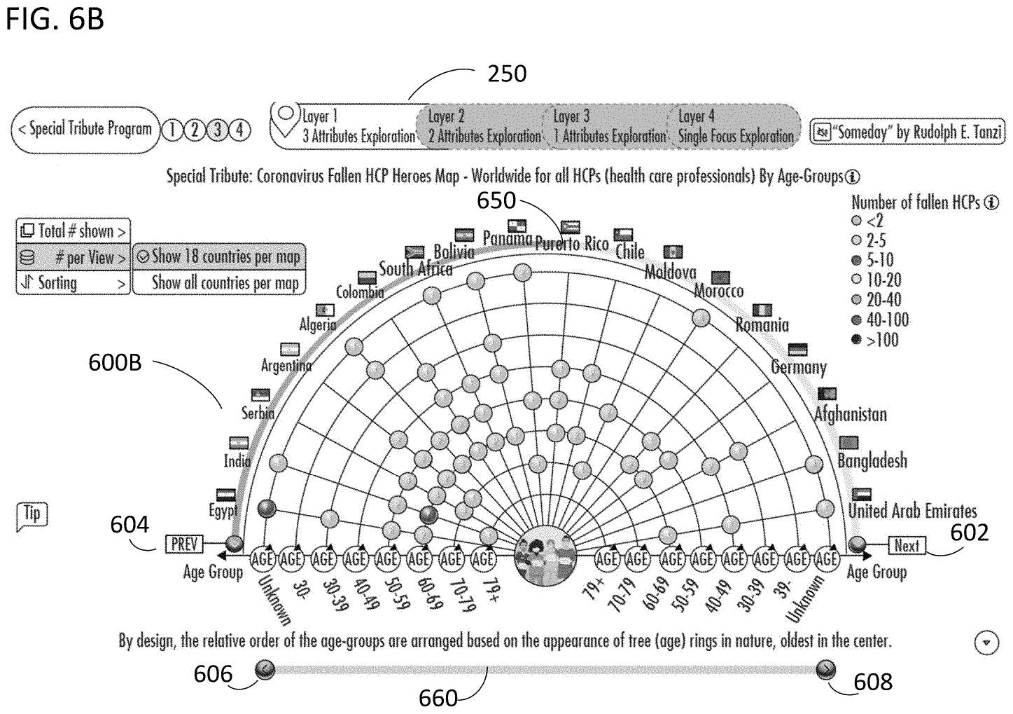

In specific embodiments of the invention, the visual maps will include user interfaces to alter the rules for how visual maps are dynamically generated and/or to navigate a visual map. The step of navigating a visual map 108 is provided in FIG. 1 and is part of the iterative process of exploring the overall data set. The interfaces can indicate to a user that not all the vector attributes for a given visual map are currently being displayed. The interfaces can also provide a user with the ability to cycle through the vector attributes that are currently being displayed. For example, if a given visual map does not have sufficient space for all the vector attribute values for a given layer of the data set, a user can be apprised of this fact by an indicator and provisioned with a button, dial, or dropdown menu, to alter the vector attribute values that are presently represented on the visual map. FIGS. 6A and 6B illustrate two different maps 600A and 600B for the same layer of the data set. The map 600A in FIG. 6A illustrates the first 18 attribute values (countries) of the complete list illustrated in FIG. 5. An interface, such as interface 504 of FIG. 5, can be provided to give the user the option to select how to visualize the same information. FIG. 6A also illustrates an indicator 602 that can inform the user that more information is available and how to access it. In the illustrated example, the indicator is in the form of a button “NEXT” which is both indicating that more information is available and suggesting that the information can be accessed by selecting such button. Other interfaces can be presented and explicative notes, such as instant messages or prompts, can be provided to instruct the user to move through the data. For example, in the illustrated example, the sign “Tip” can be blinking on the screen so that the user is guided to access it to learn how to navigate the map. The map could also include a status bar, such as status bar 650, that can indicate a percentage of the data being displayed. FIG. 6B illustrates the same map as in FIG. 6A once the indicator/button “NEXT” is actioned for the first time. A second list of 18 subsequent attribute values (countries) of the complete list illustrated in FIG. 5 is displayed. A new indicator 604 “PREV” is also provided so that the user can go back to the previous list. As illustrated, status bar 650 now indicates that half the countries have been illustrated at this point on the map.

The status bar can take on various forms. In the illustrated examples, the status bar follows the shape of the vector curves and passes along the attribute values it indicates (countries). The illustrated case is a non-limiting example of how the status bar can be represented, and other implementations are possible. FIG. 6B also illustrates additional interfaces 606 and 608 that can serve to move through the different age groups, and a corresponding status bar 660. Multiple implementations of those features are possible within the scope of the present invention. Status bars can be located at any point within the interactive VUI and be used for different purposes.

As indicated by navigation interface 250, in the three cases from FIG. 5, FIG. 6A and FIG. 6B the same layer of the data set is being explored. This is because FIGS. 6A and 6B illustrate the same map as the one illustrated in FIG. 5 for the first layer of data, but the attribute values are spatially separated and illustrated by subsets, for improved visualization effects.

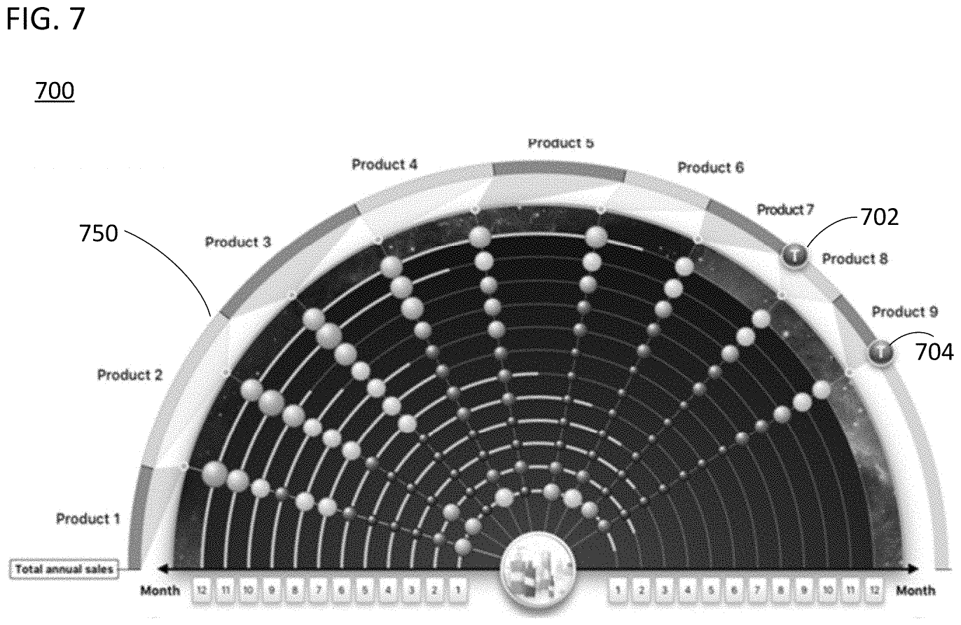

In specific embodiments of the invention, VUI generator 112 can be configured to generate the visual map in context with additional information, or to process the data to be illustrated and summarize it in various ways, so that interactive VUI provides both the detailed visual map as explained before and an additional, more general perspective of the data. FIG. 7 illustrates an example of this feature. FIG. 7 illustrates a visual map 700 that can be generated using the steps explained with reference to flow chart 100, and additionally includes an outer gauge data summary element 750. The example illustrated in FIG. 7 refers to the sales of 9 products during the year. The graphical value representations can represent an exact value per product per month, for example. The external gauge in turn can summarize the sales through the whole year. By looking only to the external gauge, it is possible to understand the overall behavior of the sales for the given products and establish a comparison between them. The gauge can also include additional elements such as indicators 702 and 704 that can refer to a target threshold for the sales and an actual value of current sales. The gauge can then be an appealing visual aspect of the overall design. It can also be a useful summary of the displayed data that integrates well with the original portions of the design. The example of FIG. 7 also illustrates partially filled vector curves representing the magnitude of the data. This feature could also be used for the line vectors to represent more dimensions of the same data set. Different color, width and format within a same curve or line vector can then be used to represent the data in various ways.

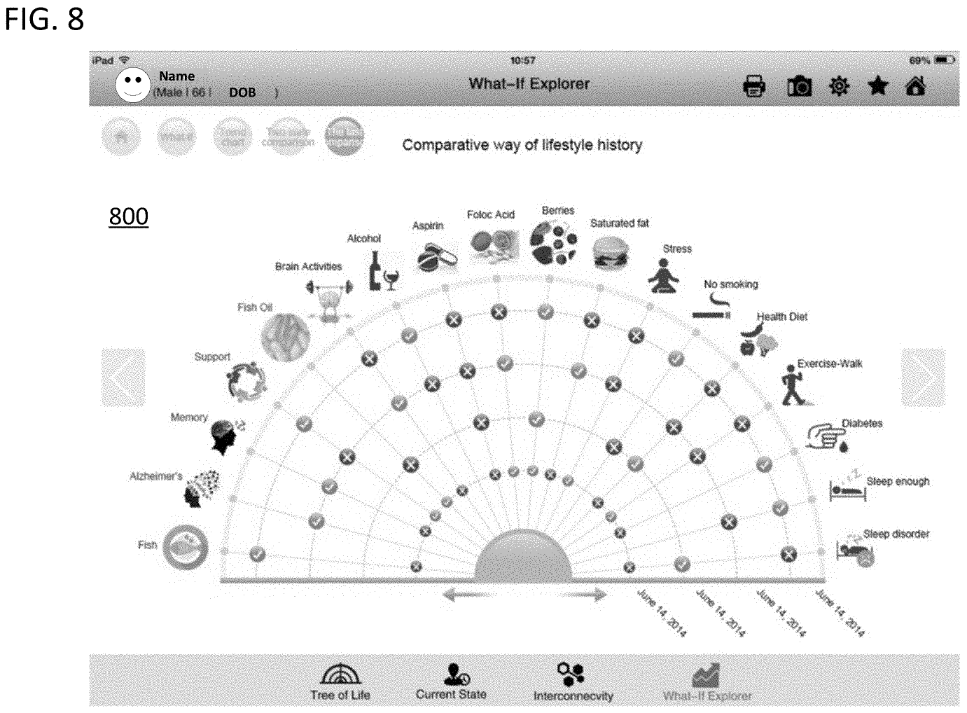

Due to the highly configurable characteristics of the interactive VUI that can be provided by the methods disclosed herewith, it can be applied to a large number of applications. FIG. 8 to FIG. 16 illustrate non-limiting examples of different uses of an interactive VUI in accordance with specific embodiments of the present invention.

FIG. 8 includes an example of a visual map 800 in accordance with specific embodiments of the invention, for a lifestyle tracking application. The example shows an 18-set of time series measurement data. There are a total number of 18 metrics (fish, Alzheimer's, memory, etc.) being measured at four different times to form an array of time series data sets. Data collected at the same time is placed onto locations on the same vector curve. The locations on the vector curves for each data point can be decided by the angle following a specific calculation algorithm.

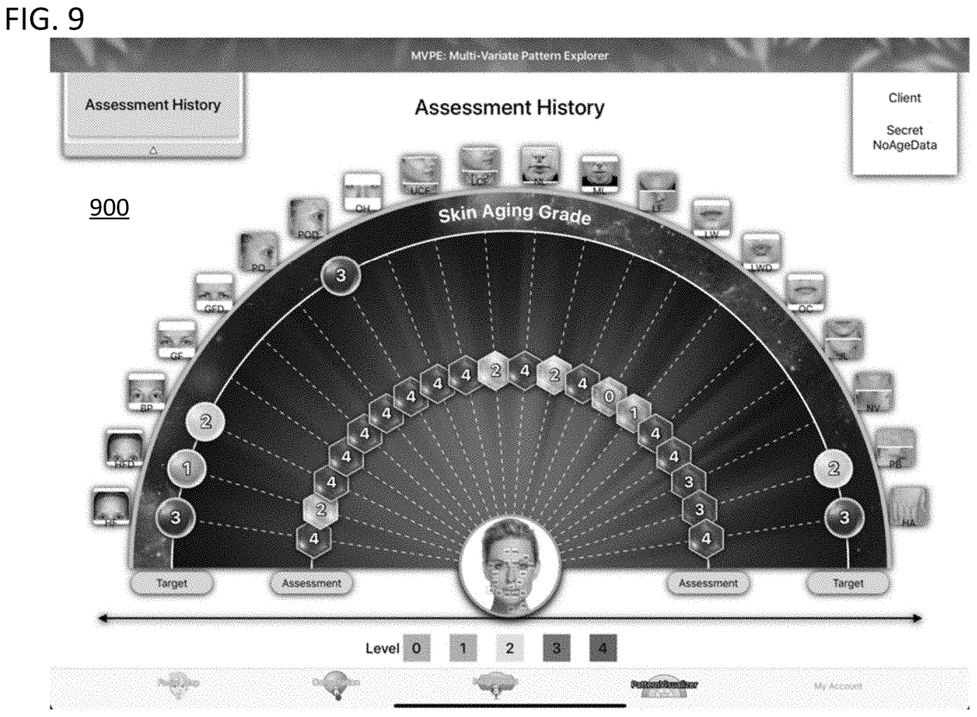

FIG. 9 includes an example of a visual map 900 in accordance with specific embodiments of the invention, for a skin care plan application. The visual map includes two vector curves for two set of data points with various representing image icons. There are 20 line vectors representing 20 different facial zones and two vector curves representing aging severity assessments and treatment plans for each facial zone. Assessment and treatment plan data are represented by different shape and color graphical value representations, depending on the aging severity level. The color legend group is shown on the bottom part of the drawing.

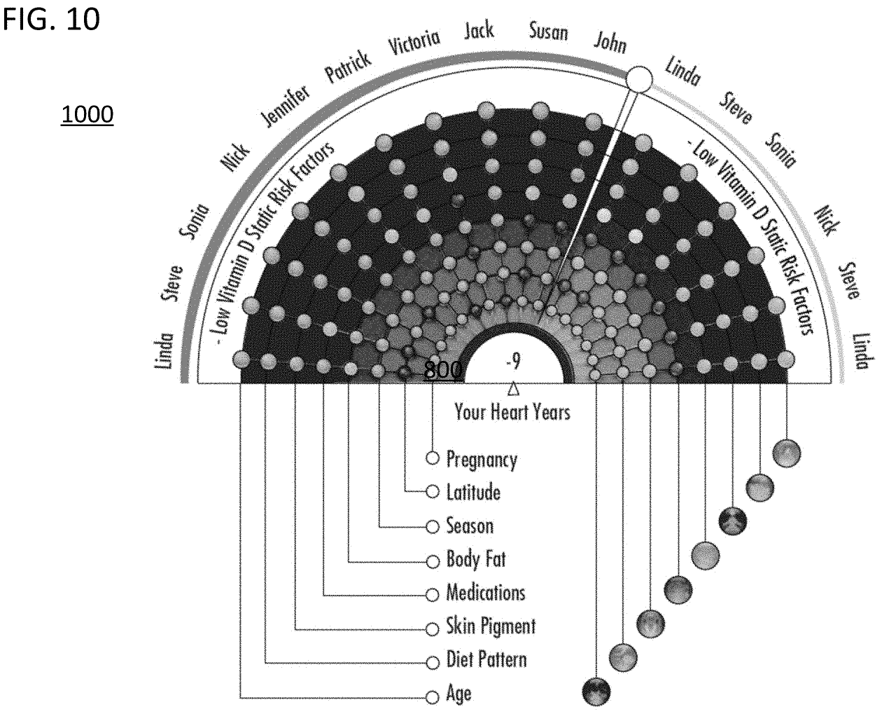

FIG. 10 includes an example of a visual map 1000 in accordance with specific embodiments of the invention, for health-related metrics analysis. The visual map includes two sections representing two different data clusters with shared metrics. There are eight rings representing metrics of Pregnancy, Latitude, Season, Body Fat, Medications, Skin Pigment, Diet Pattern and Age. There are two clusters shown on the visual map: Low Vitamin D Static Risk Factors for two groups of people taking measurements. The two groups are visually divided by a separator that can be moved toward either side to increase or decrease the angle space allocated for presenting cluster of data measurements.

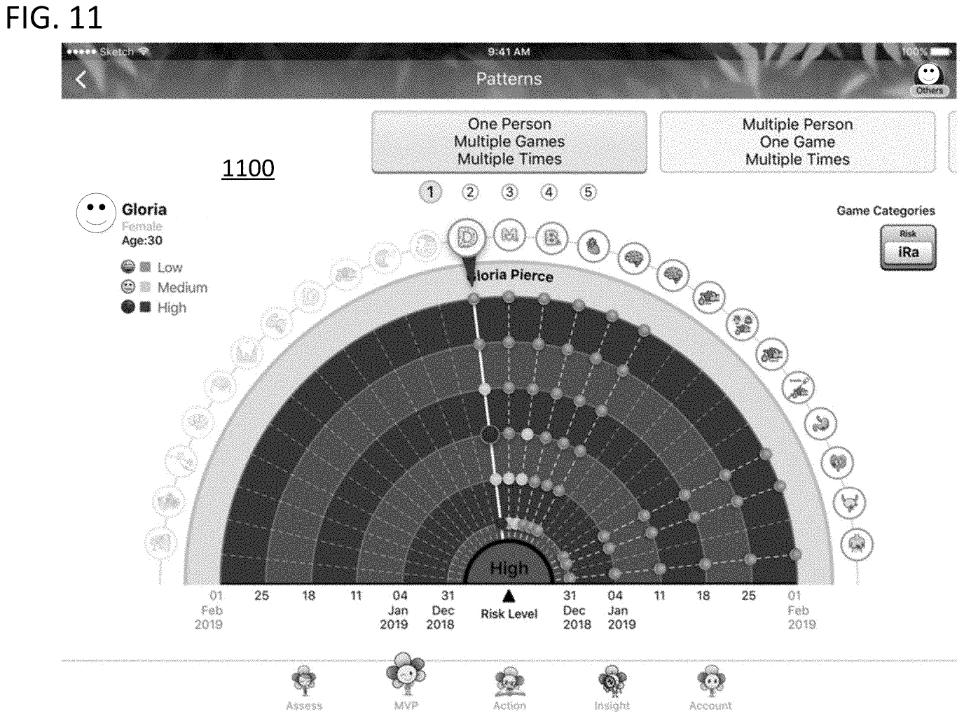

FIG. 11 includes an example of a visual map 1100 in accordance with specific embodiments of the invention, for health-related metrics and risk assessment. The visual map includes a time-series data set of metrics measurements of one person. Each metric is represented by one line vector while each measurement at a specific time is represented by a vector curve. The vector representing a metric that doesn't has measurement data is shown in gray color. The half circle block at the center is reflecting the value of the focused data point with mapped color code.

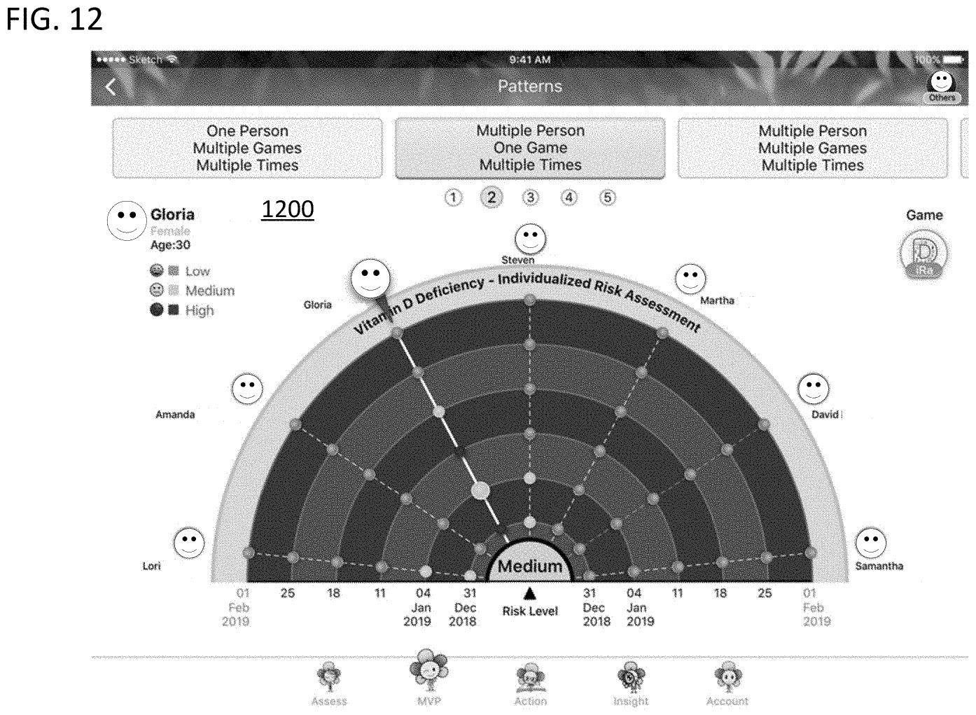

FIG. 12 includes an example of a visual map 1200 in accordance with specific embodiments of the invention, for the health-related metrics and risk assessment of FIG. 11, including data from various users at different times. The visual map shows measurements of the same metrics for multiple people at different times. Each person's measurement (multiple data points) over time (multiple times/dates) is represented by the dots on a straight line (line vector) originated from the center of the rings (vector curves), whereas the different times/dates are represented by the rings (vector curves) on the visual map.

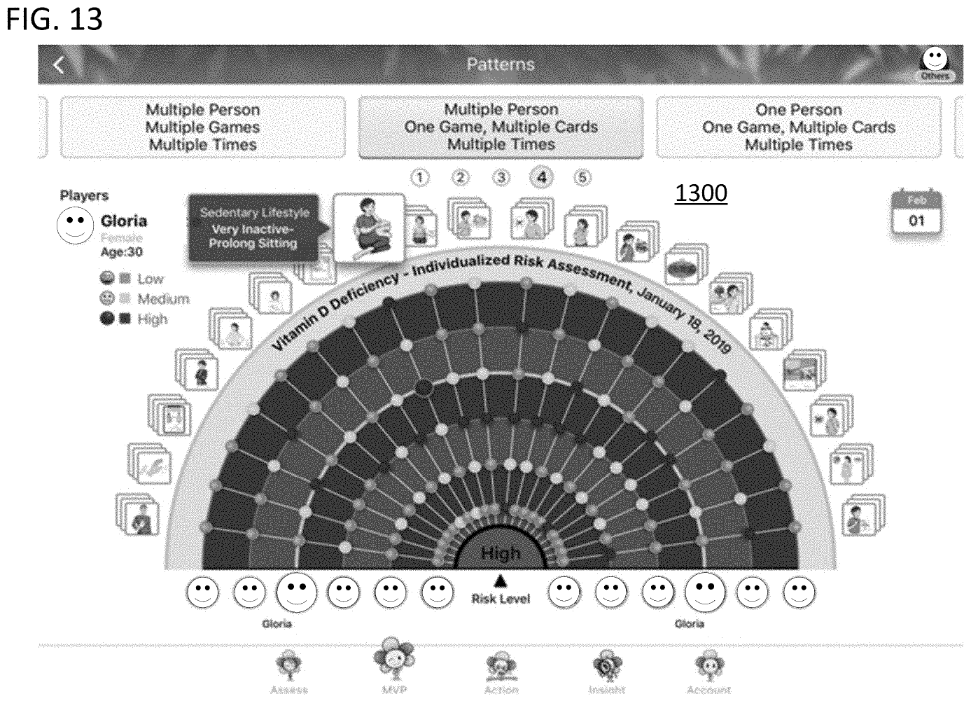

FIG. 13 includes an example of a visual map 1300 in accordance with specific embodiments of the invention, for the health-related metrics and risk assessment of FIG. 11, but including data from various users and different metrics. The visual map is showing multiple metrics measurements for multiple people with each ring (vector curve) representing one person and each line vector representing one metric. The rings center is used for displaying the focusing data while the focused data point details are also displayed on the enlarged icon picture outside the map.

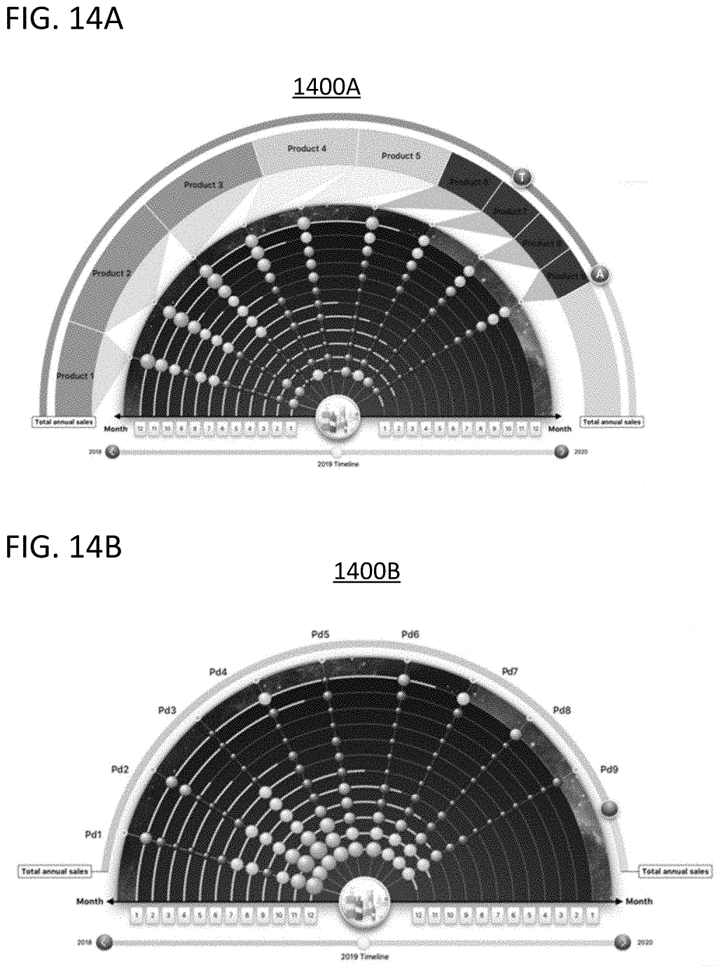

FIG. 14A and FIG. 14B include two examples of a visual map 1400A and 1400B in accordance with specific embodiments of the invention, for a sales plan tracking application. These maps include an external gauge similar to the one described with reference to FIG. 7. In this example, an external ring provides indication of goal and actual sales for the year. The example also includes a status bar and indications to move through different years on the map.

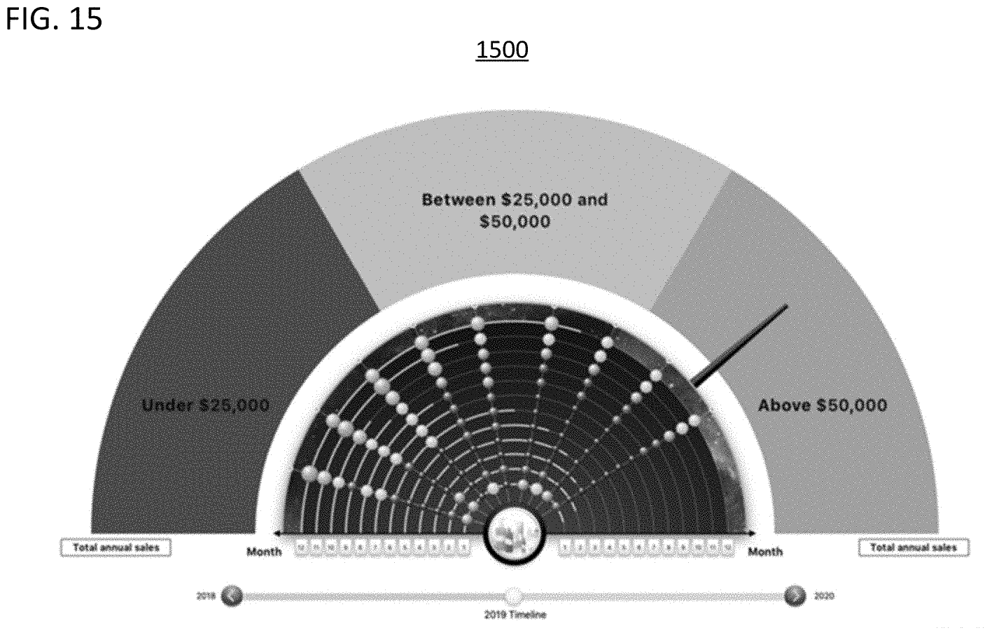

FIG. 15 include an example of a visual map 1500 in accordance with specific embodiments of the invention, with an external gauge and indicator. The visual map is similar to the maps described before with reference to FIG. 7 and FIGS. 14A and 14B. In the illustrated example, the external information is represented in a dial-type graph with an indicator that can indicate target value, an actual value etc. The external gauge and indicator can be associated to the data set that was used to generate the visual map and represent a summary or different perspective of the data.

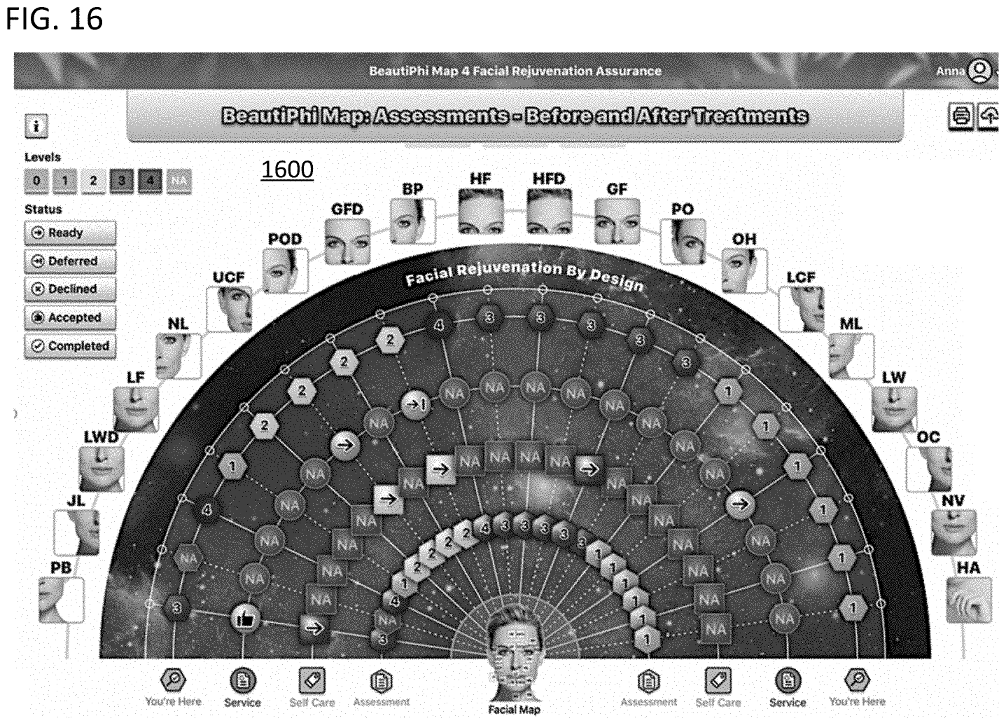

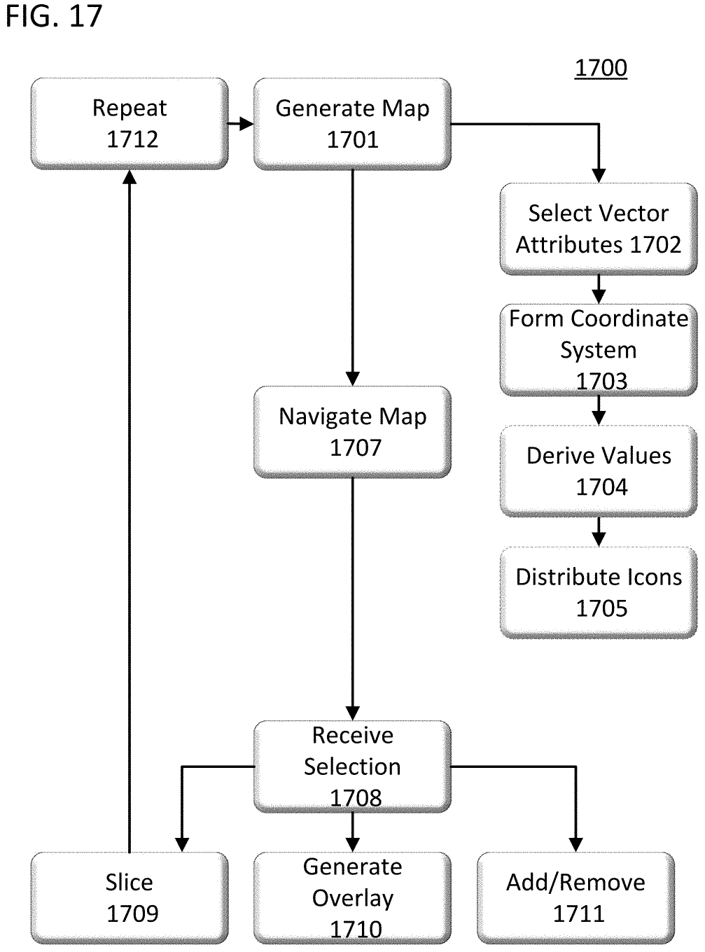

FIG. 16 includes an example of a visual map 1600 in accordance with specific embodiments of the invention, for a skin care plan application similar to the one described with reference to FIG. 9. In this case, it is illustrated that the graphical value representation can take numerous forms in the same map to illustrate different features.

The examples provided above illustrate the highly configurable VUI that can be obtained in accordance with the different embodiments of the present invention. A VUI generator, such as VUI generator 112, can have rules and be designed to provide interactive VUIs for a large number of applications and to utilize a data set in numerous ways to generate different outcomes from that data set. Complex or large data sets can then be prepared and projected so that an average user can understand the data and go as deep as the data set allows while keeping the interface intuitive, simple and visually appealing.

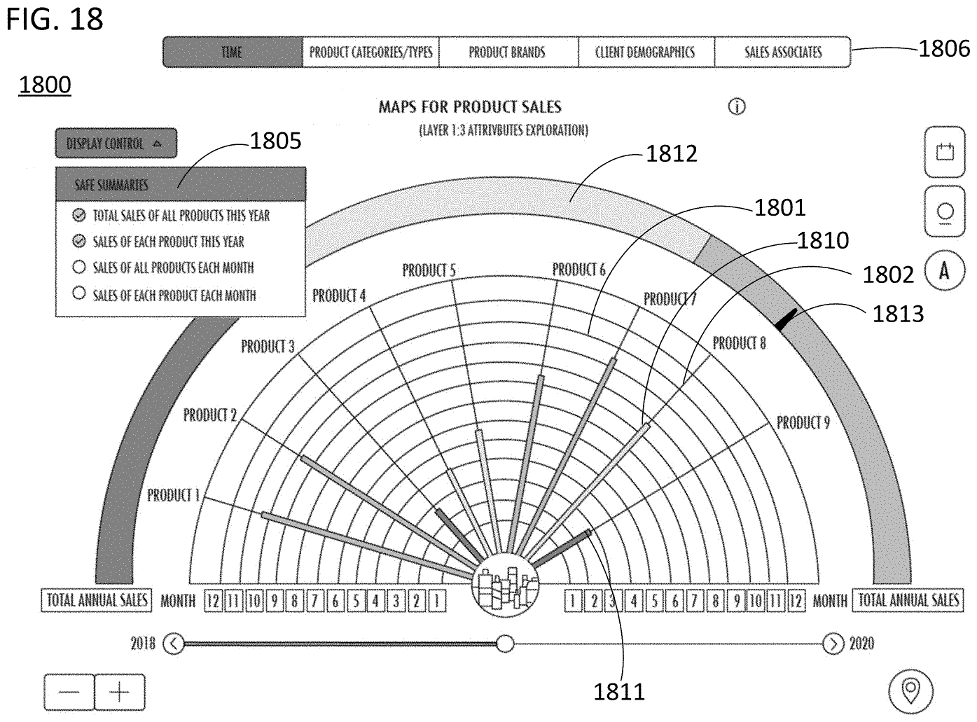

Different methods for providing an interactive VUI for a data set can be provided that can result in a different appearance and functionality for the interactive VUI. FIG. 17 illustrates a flow chart 1700 for a set of computer-implemented methods for providing an interactive VUI for a data set. As explained with reference to flow chart 100 and block diagram 110, the steps of flow chart 1700 can all be executed by VUI generator 112 operating on data set 111 to generate interactive VUI 113. Examples of the interactive VUI generated by the methods explained with reference to flow chart 1700 are illustrated in FIG. 18-23. The examples illustrate the behavior of the sales for certain products throughout the year for explicative purposes only, and this is not a limitation of the present invention.

Flow chart 1700 starts with step 1701 of generating a visual map. The visual map can be generated using the data set. The generation of the map can include a step 1702 of selecting vector attributes, for example from the attributes of the data set. Step 1702 can be the same as, or similar to, step 102 of flow chart 100. The generation of the map can also include a step 1703 of forming a physical coordinate system using a set of physical vectors. As explained with reference to flow chart 100, the physical vectors can represent values of the selected vector attributes. In specific embodiments of the invention, the set of physical vectors can include various sets of physical vectors that are combined to form the physical coordinate system.

The physical coordinate system can be formed by any distribution of physical vectors where points can be located, referenced, identified, etc. with reference to said physical vectors. In the examples discussed above where the physical vectors were in the form of line vectors and vector curves, the physical coordinate system can be formed by the combination of those two kinds of vectors representing values for different attributes of the data set. The graphical value representations distributed along the physical vectors can then be unambiguously represented in connection with the values (physical vectors) they represent, because of their position within the physical coordinate system.

FIG. 18 illustrates an example of a visual map 1800 generated in accordance with the methods of flow chart 1700. The visual map of the example in FIG. 18 illustrates the behavior of the sales for certain products throughout the year. In this way, the vector attributes selected for generating this visual map, in accordance with step 1702 of flow chart 1700, are “products” and “months”. The values for the vector attributes can be represented in the form of physical vectors on the visual map in the same way as was described before for different examples. In this example, the values for the vector attribute “products” are 9 different products (Product 1 to Product 9) represented by line vectors (or spokes) on the map. For example, line vector 1802 represents the value “Product 8” of the vector attribute “products”. The values for the vector attribute “months” are 12 months represented by vector curves (rings) on the map. For example, vector curve 1801 represents the value “11” of the vector attribute “months”. The different physical vectors can form a physical coordinate system. In this way, a graphical value representation located on the intersection of physical vectors 1801 and 1802 would unambiguously represent a value associated to the sales of product 8 in November.

As illustrated in the example of FIG. 18, visual map 1800 can include additional interfaces that can be used by a user to interact with interactive VUI 113 in various ways. The user can, via the additional interfaces, customize the way that the information is displayed. For example, interfaces such as 1805 and 1806 can be provided that allow for the selection of different features. The interfaces can include selectable elements, such as buttons, that for example trigger a certain functionality or a command for VUI generator 112 to generate new content. In this regard, flow chart 1700 includes a step 1708 of receiving a selection. Step 1708 is represented after a step 1707 of navigating the visual map. Step 1707 can be the same as, or similar to, step 108 of flow chart 100. Step 1707 can include the mere visualization of the visual map and the interaction with one or more interfaces to customize the displayed information. For example, the user can navigate the visual map 1800 by selecting an option in an interface, such as interface 1805, and select the kind of information to be displayed or the way it is displayed.

The selection received can be a selection of a vector overlay display option. A vector overlay can be an overlay that provides further characterization to the information being illustrated. For example, the vector overlay can be a physical representation of additional information to be displayed on the coordinate system, such as a pattern to be displayed over the physical vectors to illustrate a magnitude or different dimension of the data. For example, a fill pattern or colored indication can be displayed over the physical vectors to indicate a magnitude of the values represented by the physical vectors. The vector overlay can also be formed by images, text, icons, colors, textures, or any other indication that can be “laid over” the coordinate system to provide information.

Flow chart 1700 includes a step 1710 of generating an overlay. Step 1710 can be performed in response to receiving the selection of the vector overlay display option in step 1709. The overlay can be generated for at least one physical vector on the map. In this way, the overlay can be related to an attribute value associated with the physical vector. In the example of FIG. 18, an overlay is in the form of a fill pattern for the line vectors (spokes), such as fill 1810 on line vector 1802. In specific embodiments of the invention, a degree of fill on the fill pattern can relate to the attribute value. For example, the degree of the fill can indicate a magnitude of the attribute value associated with the physical vector where it is represented. As another example, the fill can relate to the attribute value in that it represents information associated with that specific attribute value. In the example of FIG. 18, fill 1810 represents the total annual sales of product 8, and does not consider any specific month. In other words, it is exclusively related to the attribute value represented by the physical vector where it is displayed, and represents an associated underlying value, the value of the annual sales. The degree of the fill can be associated with a total that can be, for example, a target sales value for the given product, or a total sales value considering all the products. For example, fill 1810 is a partial fill, that does not cover the entirety of line vector 1802. The portion of line vector 1802 covered by fill 1810 can be related to the total sales of product 8 during the year. In this way, the filled portion of the line vector can represent, for example, a percentage of the total sales for that product, with respect to a target value for the product, to the total sales values considering all the other products on the map, etc. In this way, the overlay can relate to attribute values associated with the physical vectors and does not necessarily relate to the physical coordinate system. For example, the overlay can relate to one physical vector regardless of the values represented by the others physical vectors on the map.

In the example of FIG. 18, the overlay for the line vectors, such as fill 1810, do not represent a value associated with a point or region of the physical coordinate system. The fills represent the total sales by product and the fact that they extend more or less through the vector curves does not provide information regarding the particular months represented by each vector curve. The degree of fill 1811 is smaller than the one of fill 1810 because annual sales for product 9 are smaller in value than the ones for product 8, and the position of the fills within the coordinate system does not relate to the coordinate system itself but to the attribute value and underlying data being represented (annual sales).

As represented in the example of FIG. 18, the overlay can be a set of fill patterns such as fills 1810 and 1811 for each line vector. The fill pattern of each vector can represent a percentage contribution. For example, the fill pattern can represent a percentage contribution to a total, such as a percentage contribution of the attribute value associated with each physical vector to an attribute of the data set. In this way, each fill in FIG. 18 can represent a percentage contribution of each product to the total sales of all the values (products) of the vector attribute “products”, where the total sales value can be derived from an attribute, for example a “sale value” attribute for each entry. In this case, the attribute for which a percentage is represented with the overlay is not an attribute for which a vector attribute was selected or represented in the coordinates system. As explained before, the selected vector attributes in the example of FIG. 18 are “products” and “months”. The overlay in turn represents a “sale value” attribute of the data set, and more specifically, a total annual sales value per product.

The vector overlay can then provide additional information, such as a magnitude of the data, a summary of the information, a different perspective, additional attribute's data, etc. As mentioned before, the interactive VUI can include interfaces that allow for the selection of vector overlay display options. Interface 1805 is an example of such interfaces. The user can select an option to display a vector overlay via the interfaces. In the example of FIG. 18, interface 1805 includes an option to illustrate the total sales of all products this year. By selecting this option, an overlay summary vector 1812 can be generated. The overlay summary vector can be an outermost summary vector curve, as represented by ring 1812. The overlay summary vector can represent a contribution of all the attribute values associated with the physical vectors. As illustrated in FIG. 18, the overlay summary vector 1812 represents a contribution of all the products, associated with the line vectors, for all the months, associated with the vector curves. The overlay summary vector can take on various forms and VUI generator can have rules to customize it. For example, a color code can be used to set thresholds values, and an indicator such as indicator 1813 can be used to indicate interest points, such as a current or total value, a target value, etc.

Interface 1805 also includes an option to illustrate the sales of each product in a given year. By selecting this option, the overlay for the physical vectors representing the products can be generated. In this case, the overlay is in the form of a fill pattern such as 1810 and 1811 explained before. By looking at the visual map 1800, it is possible to obtain overall useful information without digging into the details of the numerical values or specific values for each vector. For example, it is possible to understand that the annual sales were of about 80% of a given total, that product 7 leads the sells and that products 3 and 9 are not among the preferred ones. The information provided by the overlay alone can aid in the understanding of any attribute's behavior, without overcrowding the screen with numbers or icons. Additionally, the overlay can be used to provide information related to other attributes not represented in the coordinate system.

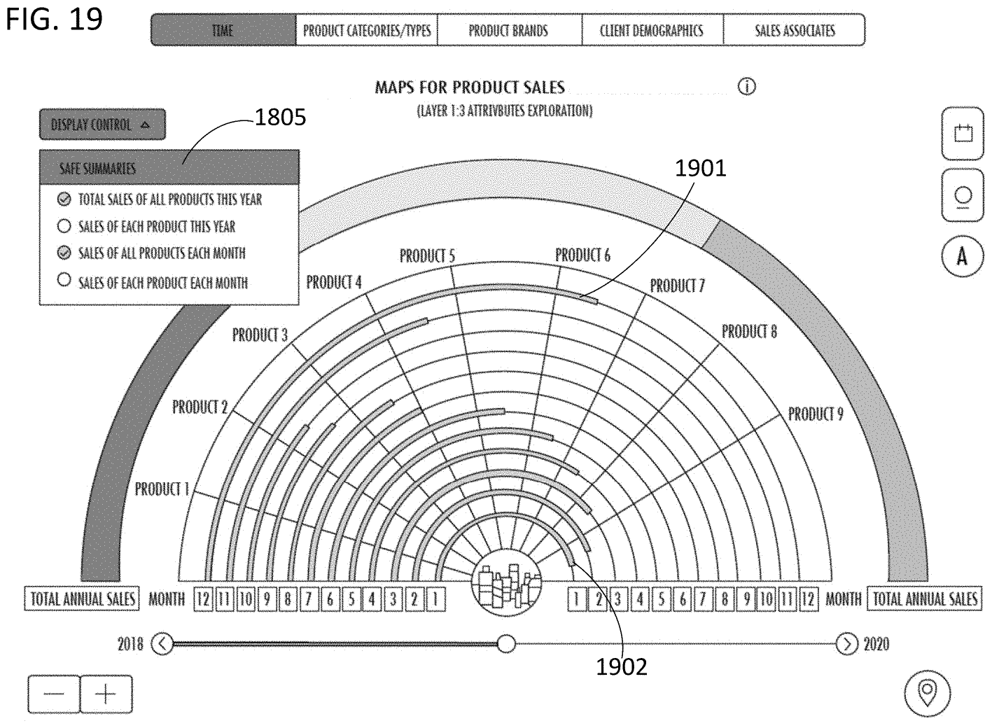

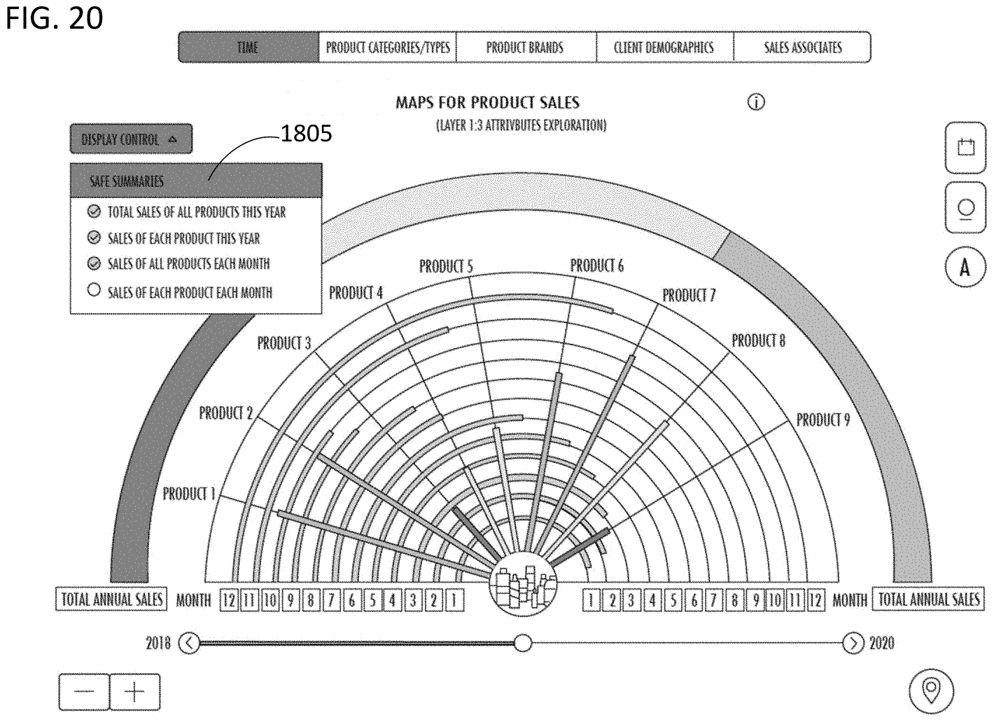

FIG. 19 illustrates a different but related example. The overlay in this example is a fill pattern for the rings, such as fills 1901 and 1902. As illustrated, an option to display the sales of all products each month can be selected via interface 1805. In this example, as in the previous one, the overlay can relate to the attribute value represented by the vector curve where the overlay is displayed and does not necessarily relate to the physical coordinate system. For example, fill 1901 can relate to December sales of all products, and the position of the fills though the spokes is not related to the value represented by the spokes (specific products) but to a total value of an additional attribute, in the case the sales value. Additionally, the degree of the fill can relate to the attribute value represented by the vector curve where the overlay is displayed. In this way, the degree of the fill can indicate a magnitude of the data or a percentage of a total, as explained with reference to FIG. 18.

VUI generator 112 can have rules to decide how to calculate the fill degree. In specific embodiments of the invention, the fill degree can be proportional to the position of the ring within the map. For example, an inner ring that is about 95% filled, as represented with fill 1902 can represent a larger absolute value than a ring that is about 65% filled, as represented with fill 1901, even though the overall extension of fill 1901 is larger. In this way, fills that are up to 50% of the rings can represent the same absolute value regardless of the diameter of the ring and corresponding extension of the fills.

FIG. 20 illustrates an example of the same visual map where both options from FIG. 18 and FIG. 19 are selected via interface 1805. As illustrated, the overlays are displayed for the different options at the same time and different information can be obtained from the map. As with FIG. 18 and FIG. 19, the overlay can comprise a set of fill patterns on the physical vectors. When the physical vectors are line vectors having a common origin, the overlay can comprise a set of fills patterns for the line vectors, and the fill patterns can extend from the common origin, as illustrated in FIGS. 18 and 20 where the fills from the spokes extend from the center of the map outwards. When the physical vectors are vector curves having a common focus, the overlay can comprise a set of fill patterns for the vector curves, and the fill patterns can extend from the same side of the common focus, as illustrated in FIG. 19 and FIG. 20, where the fill for the rings extend from left to right. However, these are not limitations of the present invention. VUI generator 112 can have rules to decide how to generate the overlay in different ways.

Flow chart 1700 includes additional steps such as step 1704 of deriving points values from the data set and step 1705 of distributing a set of graphical value representations of the point values. These steps are optional and can be the same as, or similar to, steps 103 and 104 of flow chart 100. In specific embodiments of the invention, step 1705 includes distributing the graphical value representations in accordance with the physical coordinate system. In this way, the graphical value representations can be distributed in association with the values represented by the different physical vectors that form the coordinates system. The graphical value representations can be distributed, for example, on the intersection of the different physical vectors, such as a vector curve and a line vector, and be associated to both values, as also explained with reference to flow chart 100.

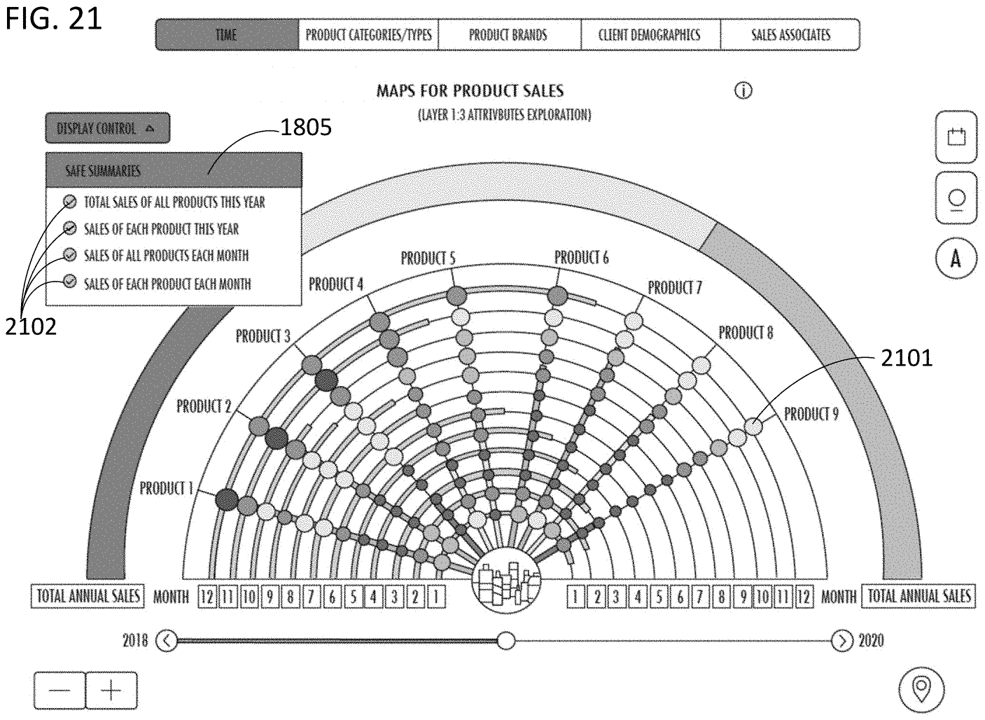

FIG. 21 illustrates an example of the same visual map including graphical value representations, such as 2101. The graphical value representation can take the same or similar characteristics as the ones described with reference to flow chart 100, and the values represented by them can be derived in the same or similar way. Interactive VUI can provide an option to select a point value display option, so that the graphical value representations can be optionally displayed on or removed from the coordinate system or the visual map. This feature can be advantageous in that the map is not overcrowded with information unless it is desired or necessary. The point value display option can also be provided as an overlay option. For example, a selection on interface 1805 of an option to display the sales for each product each month can result in an overlay being displayed over the coordinate system that comprises the graphical value representations with the information.

As illustrated in FIG. 21, all overlay display options are selected on interface 1805, and the graphical value representations are displayed together with the rings and spokes fills, and the summary vector curve. Interface 1805 can comprise selectable elements, such as buttons 2102, that provide the option for the user to independently add or remove the overlays, representations, values, etc. and customize the information being displayed. Flow chart 1700 can optionally include a step 1711 of adding and/or removing the overlays from the coordinates system, the graphical value representations from the visual map, etc. in response to receiving a selection, and the selection can be received, for example, via an interface such as buttons 2102 on interface 1805. In this way, different types of data can be selectively displayed on the same physical space even though they refer to different dimensions or content.

The step 1708 of receiving a selection in flow chart 1700 can also include the features described with reference to step 105 of flow chart 100. A selection of an attribute can be received via one of the graphical representations or physical vectors. Flow chart 1700 includes a step 1709 of slicing a selected attribute. This step can be carried out when a selection of an attribute is received and can be the same as, or similar to, step 106 of flow chart 100 and the selected attribute can be sliced from the data set to form a new layer data set. In the same way as was explained for step 107 of flow chart 100, the methods in accordance with flow chart 1700 can also include a step 1712 of repeating the generating step to generate additional visual maps with new layers data sets.

VUI generator can have rules to determine how to generate the overlays and project information on the visual maps. For example, the format of the overlays, such as the color, weight, shape, etc. can be set by VUI generator. As illustrated in FIG. 21, there can be a color code for the graphical value representations, the overlays on the physical vectors, and the summary vector curve. The color can relate to thresholds as discussed in previous examples, and provide additional information regarding the data being displayed, such as magnitude, relevance, severity, etc. The overlays can also include icons or other indications, such as for example an icon associated with a vector or on the vector to show the current fill point.

The generation of the overlay can be dynamically updated as data is updated on the data set. For example, the summary vector curve can change with a change in the contribution of the inner physical vectors, which in turn can change with a change in the value of the attribute. Graphical representations and connections between the different overlays can be provided. For example, each physical vector could have a physical connection, such as a line, to an associated portion of the summary vector curve. The overlay can also be dynamically updated to illustrate changes in the data such as when a threshold has been passed or a target has not yet been accomplished. For example, the color, shape or format of the fills could be conditioned on given values. The overlay could include icons to illustrate a target value or a current value, such as a point on the physical vectors. When the fill reaches that value, the fill can turn from red to green indicating that a target value has been reached. These and other configurations are possible due to the high configurability of VUI generator 112.

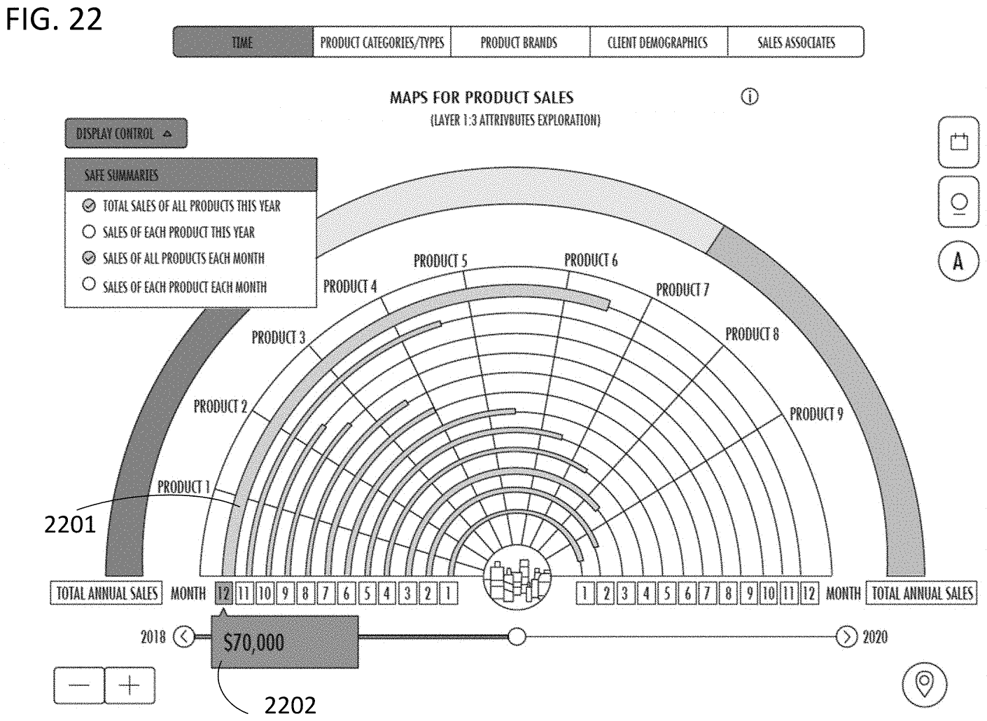

FIG. 22 illustrates an example where the visual map of FIG. 19 is being explored. In this example the overlay consist of a set of fill patterns for the vector curves, and a selection of a specific physical vector, such as the vector curve representing December, could trigger a change in the physical appearance of the overlay or even cause the displaying of further information on the map. For example, the fill 2201 can be wider than other fills on the map, because the December month is being explored. The month can be explored by a user interaction with the physical vectors or any other interface on the map. The appearance of the overlay could also change by changing the color, texture, etc. For example, a fill could become brighter than the rest of the fills in the overlay when the physical vector associated to that fill is being accessed. Other indications can be provided on the map, such as indication 2202 that provides a numerical value for the given selection. These and similar options can be customized via VUI generator 112.

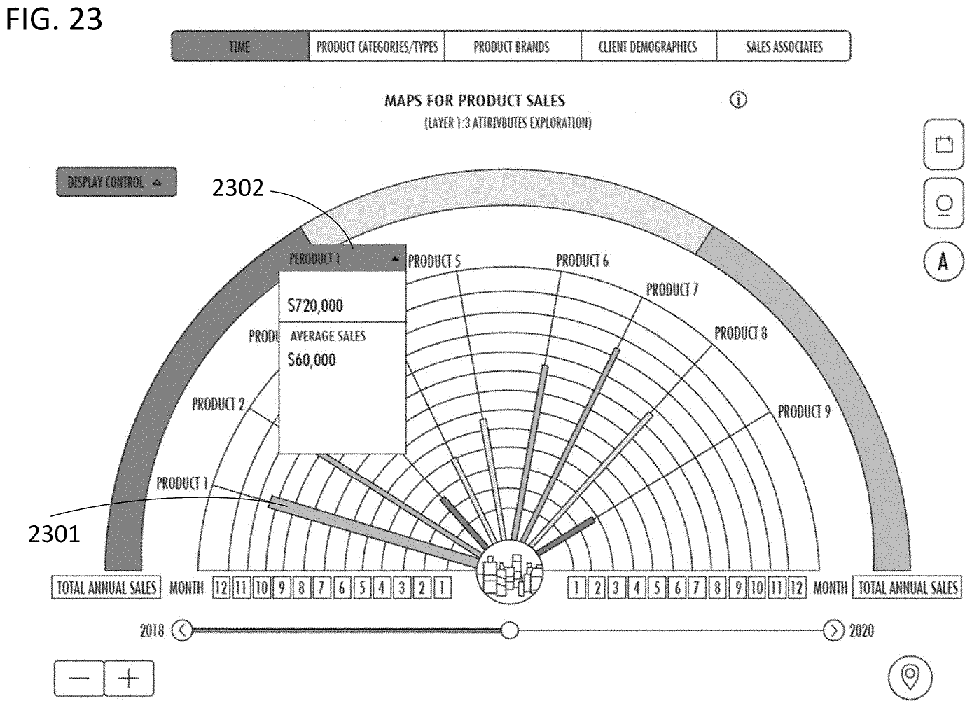

A similar example is illustrated in FIG. 23, where the visual map of FIG. 18 is being explored. In this case, the overlay consists of a set of fill patterns for the line vectors, and a selection of a specific physical vector, such as the line vector representing Product 1, could trigger a change in the physical appearance of the overlay or even cause the displaying of further information on the map. The fill 2301 can be wider than the rest of the fills in the overlay because Product 1 is being explored. Additional indications such as indication 2302 can be provided with specific information about the selected attribute.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, each visual map and view thereof can be dynamically printed as a pdf file, sent as an email, or shared on social media. Other tools for collaborative communication on an interactive display such as the ability to annotate the visual maps, provide comments, and alter the host of the interactive VUI can also be provided to enhance the collaborative experience. These and other modifications and variations to the present invention may be practiced by those skilled in the art, without departing from the scope of the present invention, which is more particularly set forth in the appended claims.

What is claimed is:

1. A computer-implemented method for providing an interactive data visualization user interface for a data set, wherein the method comprises:
generating a first visual map using the data set by:
(i) selecting, from a set of attributes of the data set, a set of vector attributes; and
(ii) forming a physical coordinate system using a set of physical vectors;
(iii) wherein the set of physical vectors represent values of the set of vector attributes;
receiving a selection of a vector overlay display option; and
generating, in response to receiving the selection of the vector overlay display option, an overlay for at least one vector in the set of physical vectors, wherein the overlay:
(i) relates to an attribute value, for an attribute from the set of attributes, associated with the at least one vector; and
(ii) does not relate to the physical coordinate system.

2. The computer-implemented method of claim 1, wherein generating the first visual map further comprises:
deriving a set of point values from the data set; and
distributing a set of graphical value representations of the set of point values in accordance with the physical coordinate system.

3. The computer-implemented method of claim 2, further comprising:
receiving a selection of a point value display option; and
removing, in response to receiving the point value display option, the set of graphical value representations from the first visual map.

4. The computer-implemented method of claim 2, further comprising:
receiving a selection of at least one selected attribute value via one of: (i) a graphical representation from the set of graphical value representations; and (ii) a vector in the set of physical vectors;
slicing the at least one selected attribute value from the data set to form a second layer data set; and
repeating the step of generating a visual map to generate a second visual map using the second layer data set.

5. The computer-implemented method of claim 1, wherein:
the overlay is a fill pattern for the at least one vector in the set of physical vectors; and
a degree of fill on the fill pattern relates to the attribute value.

6. The computer-implemented method of claim 5, wherein:
the overlay is a set of fill patterns for each vector in the set of physical vectors; and
the fill pattern of each vector represents a percentage contribution of the attribute value associated with each vector to an attribute in the set of attributes.

7. The computer-implemented method of claim 2, wherein:
the set of physical vectors include a first set of physical vectors and a second set of physical vectors;
the first set of physical vectors are a set of vector curves having a common focus;
the second set of physical vectors are a set of line vectors having a common origin; and
the set of graphical value representations are distributed on a set of intersections of the set of vector curves and the set of line vectors.

8. The computer-implemented method of claim 7, wherein:
the overlay comprises a set of at least two fill patterns on at least two vector curves in the set of vector curves; and
the fill patterns in the set of at least two fill patterns extend from the same side of the common focus.

9. The computer-implemented method of claim 7, further comprising:
the overlay comprises a set of at least two fill patterns on at least two line vectors in the set of line vectors; and
the fill patterns in the set of at least two fill patterns extend from the common origin.

10. The computer-implemented method of claim 7, further comprising:
generating an overlay summary vector;
wherein the overlay summary vector is an outermost vector curve; and
wherein the overlay summary vector represents a contribution of all the values of the set of vector attributes associated with the set of physical vectors.

11. A non-transitory computer-readable media accessible to one or more processors and storing instructions which, when executed by the one or more processors, implement a method for providing an interactive data visualization user interface for a data set, wherein the method comprises:
generating a first visual map using the data set by:
(i) selecting, from a set of attributes of the data set, a set of vector attributes; and
(ii) forming a physical coordinate system using a set of physical vectors;
(iii) wherein the set of physical vectors represent values of the set of vector attributes;
receiving a selection of a vector overlay display option; and
generating, in response to receiving the selection of the vector overlay display option, an overlay for at least one vector in the set of physical vectors, wherein the overlay:
(i) relates to an attribute value, for an attribute from the set of attributes, associated with the at least one vector; and
(ii) does not relate to the physical coordinate system.

12. The non-transitory computer-readable media of claim 11, wherein generating the first visual map further comprises:
deriving a set of point values from the data set; and
distributing a set of graphical value representations of the set of point values in accordance with the physical coordinate system.

13. The non-transitory computer-readable media of claim 12, wherein the method further comprises:
receiving a selection of a point value display option; and
removing, in response to receiving the point value display option, the set of graphical value representations from the first visual map.

14. The non-transitory computer-readable media of claim 12, wherein the method further comprises:
receiving a selection of at least one selected attribute value via one of: (i) a graphical representation from the set of graphical value representations; and (ii) a vector in the set of physical vectors;
slicing the at least one selected attribute value from the data set to form a second layer data set; and
repeating the step of generating a visual map to generate a second visual map using the second layer data set.

15. The non-transitory computer-readable media of claim 11, wherein:
the overlay is a fill pattern for the at least one vector in the set of physical vectors; and
a degree of fill on the fill pattern relates to the attribute value.

16. The non-transitory computer-readable media of claim 15, wherein:
the overlay is a set of fill patterns for each vector in the set of physical vectors; and
the fill pattern of each vector represents a percentage contribution of the attribute value associated with each vector to an attribute in the set of attributes.

17. The non-transitory computer-readable media of claim 12, wherein:
the set of physical vectors include a first set of physical vectors and a second set of physical vectors;
the first set of physical vectors are a set of vector curves having a common focus;
the second set of physical vectors are a set of line vectors having a common origin; and
the set of graphical value representations are distributed on a set of intersections of the set of vector curves and the set of line vectors.

18. The non-transitory computer-readable media of claim 17, wherein:
the overlay comprises a set of at least two fill patterns on at least two vector curves in the set of vector curves; and
the fill patterns in the set of at least two fill patterns extend from the same side of the common focus.

19. The non-transitory computer-readable media of claim 17, further comprising:
the overlay comprises a set of at least two fill patterns on at least two line vectors in the set of line vectors; and
the fill patterns in the set of at least two fill patterns extend from the common origin.

20. The non-transitory computer-readable media of claim 17, further comprising:
generating an overlay summary vector;
wherein the overlay summary vector is an outermost vector curve; and
wherein the overlay summary vector represents a contribution of all the values of the set of vector attributes associated with the set of physical vectors.

21. A computer-implemented method, wherein the method comprises:
selecting, from a set of attributes of a data set, a set of vector attributes;
forming a physical coordinate system using a set of physical vectors;
wherein the set of physical vectors represent values of the set of vector attributes; and
generating an overlay for at least one vector in the set of physical vectors, wherein the overlay:
(i) relates to an attribute value, for an attribute from the set of attributes, associated with the at least one vector; and
(ii) does not relate to the physical coordinate system.
